(19) United States
(12) Patent Application Publication
(10) Pub. No.: US 2024/0255618 A1
(43) Pub. Date: Aug. 1, 2024

(54) SCANNING MULTIPLE LIDAR SYSTEM OUTPUT SIGNALS

(71) Applicant: SiLC Technologies, Inc., Monrovia, CA (US)

(72) Inventors: Mehdi Asghari, La Canada Flintridge, CA (US); Nirmal Chindhu Warke, Saratoga, CA (US)

(21) Appl. No.: 18/104,770

(22) Filed: Feb. 1, 2023

(51) Int. Cl. G01S 7/481; G02F 1/29

(52) U.S. Cl. CPC G01S 7/4817; G02F 1/292

(57) ABSTRACT

A LIDAR system has a switch configured to direct a switch signal to one of multiple different alternate waveguides such that the alternate waveguide to which the switch directs the switch signal receives the switch signal from the switch. The switch signal carries multiple different channels. The system also includes an optical grating that receive multiple different channel output signals. Each of the channel output signals includes light from the switch signal and carries a different one of the channels. The optical grating outputs the channel output signal such that a direction that each of the channel output signals travels away from the optical grating changes in response to a change in the alternate waveguide to which the switch directs the switch signal.

### FIELD

The invention relates to optical devices. In particular, the invention relates to LIDAR systems.

### BACKGROUND

There is an increasing commercial demand for LIDAR systems that can be deployed in applications such as ADAS (Advanced Driver Assistance Systems) and AR (Augmented Reality). LIDAR systems typically scan a system output signal to multiple different sample regions within the LIDAR system's field of view. The LIDAR system generates LIDAR data for the sample regions within the field of view. The LIDAR data for a sample region indicates the radial velocity and/or a distance between the LIDAR system and an object located in the sample region.

Solid-state mechanisms for scanning the system output signals in LIDAR systems can increase the reliability of the LIDAR data and the speed at which the LIDAR data can be generated. However, solid-state scanning mechanisms become less effective as the number of sample regions and/or the size of the field of view increase. As a result, there is a need for an improved LIDAR system.

### SUMMARY

A LIDAR system has a switch configured to direct a switch signal to one of multiple different alternate waveguides. The alternate waveguide to which the switch directs the switch signal receives the switch signal from the switch. The switch signal carries multiple different channels. The system also includes an optical grating that receive multiple different channel output signals. Each of the channel output signals includes light from the switch signal and carries a different one of the channels. The optical grating outputs the channel output signal such that a direction that each of the channel output signals travels away from the optical grating changes in response to a change in the alternate waveguide to which the switch directs the switch signal.

A method of operating a LIDAR system includes directing a switch signal to one of multiple different alternate waveguides. The alternate waveguide to which the switch signal is directed receives the switch signal from the switch. The switch signal carries multiple different channels. The method also includes receiving multiple different channel output signals at an optical grating. Each of the different channel output signals includes light from the switch signal and carries a different one of the channels. The method further includes changing the alternate waveguide to which the switch directs the switch signal. A direction that each of the channel output signals travels away from the optical grating changes in response to the change in the alternate waveguide to which the switch directs the switch signal.

### BRIEF DESCRIPTION OF THE FIGURES

FIG. 1A is a top view of a LIDAR chip.

FIG. 1B illustrates a light source that includes multiple laser sources.

FIG. 2 is a top view of a LIDAR chip.

FIG. 3 is a top view of a LIDAR chip.

FIG. 4 is a top view of a LIDAR chip.

FIG. 5 is a top view of a LIDAR assembly that includes a LIDAR adapter in optical communication with an LIDAR chip.

FIG. 6A is a topview of a system having a scanning chip being used with an adapter constructed according to FIG. 5.

FIG. 6B is a topview of system having a scanning chip used in conjunction with a signal director and a transmission optical grating.

FIG. 6C is a topview of system having a scanning chip used in conjunction with a signal director and a reflective optical grating.

FIG. 7A is a topview of a LIDAR system that include the LIDAR chip disclosed in the context of FIG. 1A, the LIDAR adapter disclosed in the context of FIG. 5, and the scanning chip, signal redirector, and optical grating disclosed in the context of FIG. 6B.

FIG. 7B is a topview of a portion of another embodiment of a LIDAR system that include the LIDAR system of FIG. 7A in combination with multiple steering components.

FIG. 8 is a cross section of a portion of a suitable reflective optical grating.

FIG. 9A illustrates an example of a processing component suitable for use with the LIDAR systems.

FIG. 9B provides a schematic of electronics that are suitable for use with a processing component constructed according to FIG. 7A.

FIG. 9C is a graph of frequency versus time for a system output signal with triangular frequency tuning.

FIG. 9D illustrates another example of a processing component suitable for use with the LIDAR systems.

FIG. 9E provides a schematic of electronics that are suitable for use with a processing component constructed according to FIG. 7D.

FIG. 10A and FIG. 10B illustrate an example of a suitable control component for use as all or a fraction of the control components disclosed in the context of FIG. 1A through FIG. 4. FIG. 10A illustrates an interface between optical components and light sensors that can be positioned on a LIDAR chip.

FIG. 10B is a schematic of a relationship between the electronics and light sensors that can be included on a LIDAR chip.

FIG. 10C is a graph showing an amplitude for an in-phase and quadrature components of a signal on the same time axis with the frequency of the system output signal.

FIG. 10D illustrates one example of a process variable identification component suitable for use in the electronics of a LIDAR system.

FIG. 10E illustrates another example of a process variable identification component suitable for use in the electronics of a LIDAR system.

FIG. 11 is a topview of a portion of a waveguide that includes a spiral waveguide.

FIG. 12A is a cross-section of portion of a LIDAR chip that includes a waveguide on a silicon-on-insulator platform.

FIG. 12B through FIG. 12D illustrate an example of a return device constructed on a silicon-on-insulator platform and suitable for use on a LIDAR chip constructed according to FIG. 2 and FIG. 4. FIG. 12B is a topview of a portion of a LIDAR chip that has the return device.

FIG. 12C is a cross section of the return device taken along the line labeled C in FIG. 12B.

FIG. 12D is a cross section of the return device taken along the line labeled C in FIG. 12B.

FIG. 13A is topview of a portion of a LIDAR chip that includes an echelle grating.

FIG. 13B is a cross section of the echelle grating taken through a signal redirector included on the LIDAR chip of FIG. 13A. The cross section is taken along the line labeled E in FIG. 13A.

FIG. 13C is a cross section of another embodiment of the echelle grating.

FIG. 13D is a close-up topview of a portion of the return surface.

FIG. 14 is a topview of an example of an optical switch.

FIG. 15A illustrates the control assembly of FIG. 4 modified such that a control component concurrently receives a series of different channels.

FIG. 15B illustrates the control assembly of FIG. 15A modified such that tapped signals are tapped from reference waveguides rather than source waveguides.

FIG. 16 is topview of a LIDAR system that excludes a LIDAR adapter.

### DESCRIPTION

A solid-state scanner for use in LIDAR systems includes a signal redirector such as a lens. The signal redirector receives multiple channel output signals from a portion of the channel output waveguides included in a switch system. The switch system can be operated so as to change the selection of channel output waveguides from which the redirector receives the channel output signals. The signal redirector is configured to redirect the channel output signals such that a direction that each of the channel output signals travels away from the signal redirector changes in response to a change in the selection of channel output waveguides from which the redirector receives the system output signals.

It is often desirable to increase the number of channel output signals in order to increase the number of sample regions that can be scanned per unit. In many LIDAR systems, the desired sample region scan rate is achieved by using 16 or more output signals. Additionally, the angular resolution of the LIDAR system can be increased by decreasing the distance between the channel output waveguides. However, decreasing this distance reduces the size of the field of view that can be scanned. An optical grating receives the channel output signals from the signal redirector and outputs at least a portion of each one of the channel output signals. The optical grating can provide additional dispersion of the channel output signals beyond the dispersion provided by the signal redirector. The level of dispersion is selected to expand the field of view to the desired size. Accordingly, the LIDAR system can have a number of output channels that provides the desired sample region scan rate and an enhanced angular resolution while also a field of view with the desired dimensions.

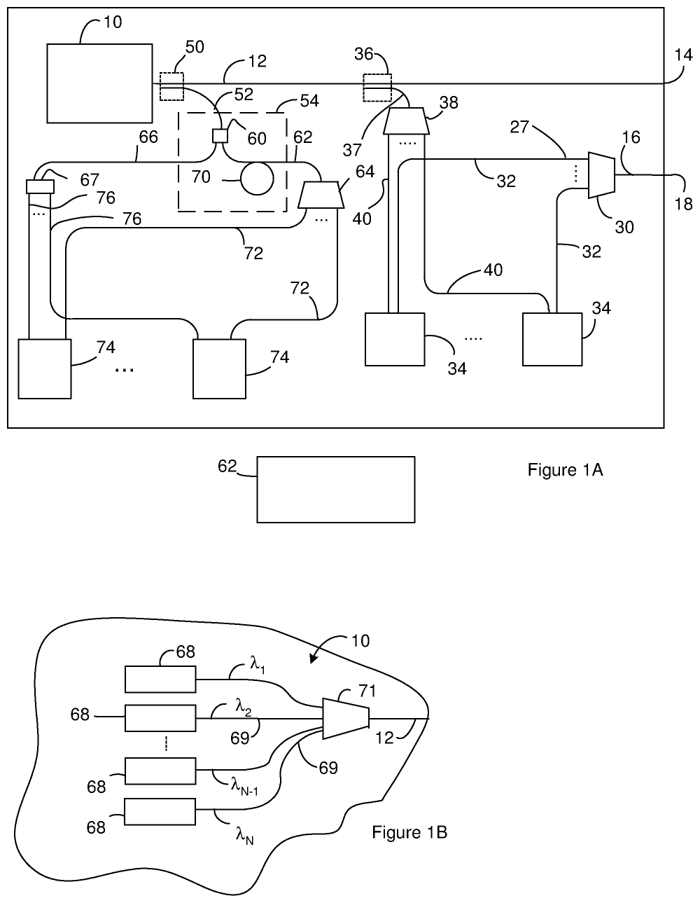

FIG. 1A is a topview of a LIDAR chip configured to generate composite signals that are each beating at a beat frequency that can be used by electronics to generate LIDAR data. The LIDAR chip includes a photonic integrated circuit. The photonic circuit can include a light source 10 that outputs an outgoing LIDAR signal. The outgoing LIDAR signal includes one or more different channels that are each at a different wavelength. The wavelengths of the channels can be periodically spaced in that the wavelength increase from one channel to the next channel (the channel spacing) is constant or substantially constant. In some instances, the channels spacing is constant and greater than 0.5 nm, 1 nm, 3 nm, or 5 nm, and/or less than 10 nm, 15 nm, or 20 nm. In some instances, the number of channels, N, is greater than 2, 4 or 8 and/or less than 16, 32, or 64. A suitable light source 10 for generating multiple channels with periodically spaced wavelengths includes, but is not limited to, comb lasers and one or more single wavelength and/or one or more multiple wavelength lasers with outputs multiplexed into an outgoing LIDAR signal.

The LIDAR chip also includes a utility waveguide 12 that receives the outgoing LIDAR signal from the light source 10. The utility waveguide 12 terminates at a facet 14 and carries the outgoing LIDAR signal to the facet 14. The facet 14 can be positioned such that the outgoing LIDAR signal traveling through the facet 14 exits the chip and serves as a LIDAR output signal. For instance, the facet 14 can be positioned at an edge of the chip so the outgoing LIDAR signal traveling through the facet 14 exits the chip and serves as a LIDAR output signal.

The LIDAR output signal travels away from the chip and may be reflected by objects in the path of the LIDAR output signal. The reflected signal travels away from the objects. When the LIDAR output signal is reflected, at least a portion of the light from the reflected signal is returned to an input waveguide 16 on the LIDAR chip as a LIDAR input signal. The input waveguide 16 includes a facet 18 through which the LIDAR input signal can enter the input waveguide 16. The portion of the LIDAR input signal that enters the input waveguide 16 can be considered an incoming LIDAR signal. The input waveguide 16 carries the incoming LIDAR signal to comparative demultiplexer 30. When the incoming LIDAR signal includes multiple channels, the comparative demultiplexer 30 divides the incoming LIDAR signal into different comparative signals that each carries a different one of the channels. The comparative demultiplexer 30 outputs the comparative signals on different comparative waveguides 32. The comparative waveguides 32 each carry one of the comparative signals to a different processing component 34.

The LIDAR chip includes a splitter 36 that moves a portion of the outgoing LIDAR signal from the utility waveguide 12 onto a reference waveguide 37 as a reference signal. Suitable splitters 36 include, but are not limited to, optical couplers, y-junctions, and MMIs.

The reference waveguide 37 carries the reference light signal to a reference demultiplexer 38. When the reference light signal includes multiple channels, the reference demultiplexer 38 divides the reference light signal into different reference signals that each has a different wavelength. The reference demultiplexer 38 outputs the reference signals on different reference waveguides 40. The reference waveguides 40 each carry one of the reference signals to a different one of the processing components 34.

The comparative waveguides 32 and the reference waveguides 40 are configured such that a comparative signal and the corresponding reference signal are received at the same processing component 34. For instance, the comparative waveguides 32 and the reference waveguides 40 are configured such that the comparative signal and the reference signal of the same wavelength and/or carrying the same channel are received at the same processing component 34.

As will be described in more detail below, the processing components 34 each combines a comparative signal with the corresponding reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a control assembly for controlling operation of the light source 10 and/or one or more features of a system output signal. The control assembly includes a splitter 50 that moves a portion of the outgoing LIDAR signal from the utility waveguide 12 onto a control waveguide 52. The coupled portion of the outgoing LIDAR signal serves as a tapped signal. The splitter 50 can be a wavelength independent splitter such as a directional coupler, optical coupler, y-junction, tapered coupler, and Multi-Mode Interference (MMI) device.

The control waveguide 52 carries the tapped signal to a differential delay mechanism 54 that can be a primary source of a delay between a delayed pathway signal and an expedited pathway signal. The delay mechanism 54 includes a splitter 60 that receives the tapped signal and divides the tapped signal into a delayed signal and an expedited signal. The splitter 60 can be a wavelength independent splitter. For instance, the splitter 60 can be configured such that the delayed signal and the expedited signal carry the same or substantially the same selection of wavelengths. Accordingly, the delayed signal and the expedited signal can each carry multiple channels. In some instances, the delayed signal and the expedited each carries each of the channels. Suitable splitters 60 include, but are not limited to, directional couplers, optical couplers, y-junctions, tapered couplers, and Multi-Mode Interference (MMI) devices.

A delay waveguide 62 carries the delayed signal to a first splitter 64. An expedited waveguide 66 carries the expedited signal to a second splitter 67. The delay waveguide 62 can include a delay section 70 that can be used to increase the length of the delay waveguide beyond the length of the expedited waveguide 66. For instance, the delay section 70 shown in FIG. 1A can represent a spiral arrangement of the delay waveguide 62. The longer length of the delay waveguide 62 creates the delay between the delayed signal and the expedited signal.

The first splitter 64 divides the delayed signal into delayed channel signals that are each carried on a different delayed channel waveguide 72. The first splitter 64 can be a wavelength dependent splitter. For instance, the first splitter 64 can be configured such that each of the delayed channel signals carries a different selection of wavelengths. As an example, the first splitter 64 can be configured such that each of the delayed channel signals carries a different one of the channels. Each of the delayed channel waveguide 72 carries one of the delayed channel signals to a different control component 74. As a result, each of the control components 74 receives a delayed channel signal carrying a different channel. Accordingly, each of the control components 74 can be associated with a different channel. Suitable first splitters 64 include, but are not limited to, demultiplexers such as arrayed waveguide gratings, echelle gratings, and ring resonator based devices.

The second splitter 67 divides the expedited signal into expedited sub-signals that are each carried on a different expedited sub-waveguide 76. The second splitter 67 can be a wavelength dependent splitter. For instance, the second splitter 67 can be configured such that each of the expedited sub-signals carries the same or substantially the same selection of wavelengths. Accordingly, each of the expedited sub-signals can carry multiple channels. In some instances, each of the expedited sub-signals carries each of the channels. Each of the expedited sub-waveguide 76 carries one of the expedited sub-signals to a different one of the control component 74. As a result, each of the control components 74 can receive an expedited sub-signal that carries the channel associated with that control component 74 and also carries one or more other channels. Accordingly, each of the control components 74 can receive an expedited sub-signal and a delayed channel signal that carry that same channel. Suitable second splitters 67 include, but are not limited to, directional couplers, optical couplers, y-junctions, tapered couplers, and Multi-Mode Interference (MMI) devices.

In some instances, the second splitter 67 is a wavelength dependent splitter. A wavelength dependent splitter that serves as the second splitter 67 can be configured such that the expedited sub-signals each carries a different one of the channels. Additionally, the expedited sub-waveguides 76 can be configured such that the expedited sub-signal that is received by each control component 74 carries the channel that is associated with that control component 74. As a result, each control component 74 can receive the expedited sub-signal that carries the same channel as the delayed channel signal that is received by the control component 74.

As is evident from the above description, light from the tapped signal travels on one of several different delay pathways from a splitter 60 to a combiner in one of the control components 74. Each of the delay pathways is primarily defined by the delay waveguide 62, the first splitter 64, and one of the delayed channel waveguides 72. Each of the delay pathways is traveled by a delay pathway signal that is a combination of the delay signal and one of the delayed channel signals. Light from the tapped signal also travels one of several different expedited pathways from the splitter 60 to a control component 74. The expedited pathways are each defined primarily by the expedited sub-waveguide 76, the second splitters 67, and one of the expedited sub-waveguides 76. Each of the expedited pathways is traveled by an expedited pathway signal that is a combination of the expedited signal and one of the expedited sub-signals.

Each of the delay pathways has a common portion and a separated portion. The common portion of each delay pathway is shared by the delay pathways. In contrast, the separated portion of a delay pathways is not shared with the other delay pathways. The light signals that travel through the common portion can carry multiple different channels. The light signals that travel through the separated portions can each carry a different channel. For instance, the delay waveguide 62 is common to each of the delay pathways and serves as the common portion. In contrast, the delayed channel waveguides 72 are each separated from the other delayed channel waveguides 72 and serve as a separated portion.

Each of the expedited pathways has a common portion and a separated portion. The common portion of each expedited pathway is shared by the expedited pathways. In contrast, the separated portion of an expedited pathways is not shared with the other expedited pathways. The light signals that travel through the common portion can carry multiple different channels. The light signals that travel through the separated portions can each carry a different channel. For instance, the expedited waveguide 66 is common to each of the delay pathways and serves as a common portion. In contrast, each of the expedited sub-waveguide 76 is separated from the other expedited sub-waveguide 76 and can serve as a separated portion.

The expedited pathways and the delayed pathways are configured such that each control component 74 receives a delayed pathway signal and an expedited pathway signal that carry the same channel (the common channel). The expedited pathways and the delayed pathways can be configured such that each of the different control components 74 receives a delayed pathway signal and an expedited pathway signal that carry a different common channel. Additionally, the delay pathways and the expedited pathways can be configured such that the delay pathway signal and/or the expedited pathway signal received at each of the control components 74 carries only one of the channels or carries essentially only one of the channels.

The components that define the delay pathways and the expedited pathways are configured such that an expedited pathway signal and a delayed pathway signal that arrive at the same the control component 74 have the arrival of the delayed pathway signal at the control component 74 delayed relative to the arrival of the expedited pathway signal at the control component 74.

Because the delayed pathway signal and the expedited pathway signal include different portions of the tapped signal, each control component 74 receives a delayed portion of the tapped signal and also receives an expedited portion of the tapped signal with the delayed portion being delayed relative to the tapped portion. The components that define the delayed pathway and the expedited pathway can be configured to provide the delay between the tapped portion and the expedited portion arriving at the control component 74. For instance, the waveguides that define the delayed pathways and the waveguides that define the expedited pathways can be configured such that the delayed pathway is longer than the expedited pathway by a length that provides the delays desired at each control component 84. The length of the delay section 70 can be the primary source of the length difference between the delay pathway and the expedited pathway that leads to the same control component 74. As is evident from FIG. 1A, a delay signal that carries the different channels travels through the same delay section 70. As a result, the same delay section 70 is common to each of the delay pathways and each of the channels.

Additional details about the configuration and operation of the control assembly can be found in U.S. patent application Ser. No. 17/244,869, filed on Apr. 29, 2021, entitled “Reducing Signal of LIDAR System Control Assemblies,” and incorporated herein in its entirety.

Although the light source 10 is shown as being positioned on the LIDAR chip, all or a portion of the light source 10 can be located off the LIDAR chip. FIG. 1B illustrates an example of a light source 10 that includes multiple laser sources 68. The light sources of FIG. 1B can be located off the LIDAR chip, positioned on the LIDAR chip, or integrated on the LIDAR chip. In some instances, each of the laser sources 68 outputs a channel signal on a source waveguide 69. Each channel signal can carry one or more of the channels. For instance, FIG. 1B illustrates one possible arrangement where the source waveguide 69 that guides the channel signal that carries channel i is labeled λᵢ where i represents a wavelength channel index and the wavelength channel(s) are each associated with wavelength channel index i=1 through i=N.

Each of the source waveguides 69 carries a channel signal to a laser multiplexer 71 that combines the channel signals so as to form a light signal that is received on a channel waveguide or the utility waveguide 12. Suitable laser multiplexers 72 include, but are not limited to, Arrayed Waveguide Grating (AWG) multiplexers, echelle grating multiplexers, and star couplers. The electronics can operate the laser sources 68 so the laser sources 68 concurrently output each of the channels. The electronics can operate the laser sources 68 so the laser sources 68 concurrently output each of the channels.

In some instances, each of the laser sources 68 outputs one of the channels on a source waveguide 69. The total number of laser sources 68 included in the light source 10 can be greater than or equal to the number of LIDAR output signals that are concurrently directed to a sample region. In some instances, total number of laser sources 68 included in the light source 10 is equal to the number of LIDAR output signals that are concurrently directed to a sample region. As a result, each laser sources 68 can be the source of a different one of the LIDAR output signals that are concurrently directed to a sample region.

The electronics 62 can operate the laser sources 68 independently. For instance, the electronics can operate the laser sources 68 so as to provide particular LIDAR output signal(s) with a particular frequency versus time waveform. Since the electronics can operate the laser sources 68 independently and each laser sources 68 can be the source of a different one of the LIDAR output signals, the electronics can operate the laser sources 68 so different LIDAR output signals have different frequency versus time waveforms.

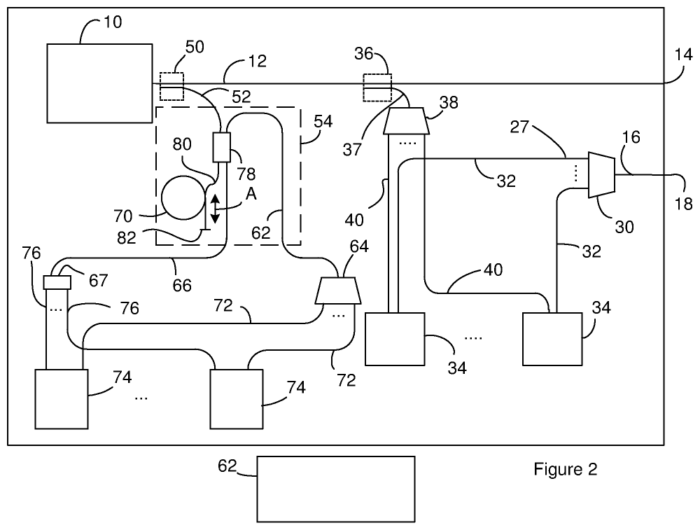

FIG. 2 illustrates the LIDAR chip of FIG. 1A and FIG. 1B modified to reduce the length of the delay section 70. The splitter 78 receives the tapped signal from the control waveguide 52 and divides the tapped signal into the expedited signal and a first delayed signal. The expedited signal is received on the expedited waveguide 66 as disclosed in the context of FIG. 1. Suitable splitters 78 include, but are not limited to, Multi-Mode Interference couplers (MMIs), and directional couplers.

A first delay waveguide 80 receives the first delayed signal from the splitter 78. The first delay waveguide 80 carries the first delayed signal to a return device 82. The return device 82 is configured to return the first delayed signal to the first delay waveguide 80 such that the first delayed signal travels from the return device 82 back through the first delay waveguide 80 to the splitter 78. As a result, the first delayed signal travels through the first delay waveguide 80 twice. For instance, the first delayed signal travels through the first delay waveguide 80 once in each direction as illustrated by the arrow labeled A in FIG. 2. Suitable return devices 82 include, but are not limited to, mirrors, and reflective surfaces.

The splitter 78 receives the first delayed signal from the first delay waveguide 80 and outputs the first delay signal on the delay waveguide 62. The portion of the first delayed signal received on the delay waveguide 62 serves as a second delay signal carried on the delay waveguide 62. The delay waveguide 62 carries the second delay signal to the first splitter 64. Accordingly, light from the tapped signal travels from the splitter 78 through the first delay waveguide 80 twice and the delay waveguide 62 once before being received at the first splitter 64. As a result, the first delay signal and the second delay signal together effectively serve as the delay signal disclosed in the context of FIG. 1A.

The first delay waveguide 80 includes the delay section 70. The light traveling through the first delay waveguide 80 twice increases the effective pathlength that the delay signal travels between the splitter 78 and the first splitter 64. This increase in the effective pathlength allows the length of the delay section 70 to be reduced in order to provide the desired delay between the delay signal and the expedited signal.

As is evident from the above description of FIG. 2, light from the tapped signal travels on one of several different delay pathways from the splitter 78 to one of the control components 74. Each of the delay pathways is primarily defined by the first delay waveguide 80, the splitter 60, the delay waveguide 62, the first splitter 64, and one of the delayed channel waveguides 72. Each of the delay pathways is traveled by a delay pathway signal that is a combination of the first delayed signal, the second delayed signal, and one of the delayed channel signals. Light from the tapped signal also travels one of several different expedited pathways from the splitter 78 to a control component 74. The expedited pathways are each defined primarily by the expedited waveguide 66, the second splitter 67, and one of the expedited sub-waveguides 76.

Each of the delay pathways has a common portion and a separated portion. The common portion of each delay pathway is shared by the delay pathways. In contrast, the separated portion of a delay pathways is not shared with the other delay pathways. The light signals that travel through the common portion can carry multiple different channels. The light signals that travel through the separated portions can each carry a different channel. For instance, first delay waveguide 80 and the delay waveguide 62 is common to each of the delay pathways and serves as the common portion. In contrast, the delayed channel waveguides 72 are each separated from the other delayed channel waveguides 72 and serve as a separated portion.

Each of the expedited pathways has a common portion and a separated portion. The common portion of each expedited pathway is shared by the expedited pathways. In contrast, the separated portion of an expedited pathways is not shared with the other expedited pathways. The light signals that travel through the common portion can carry multiple different channels. The light signals that travel through the separated portions can each carry a different channel. For instance, the expedited waveguide 66 is common to each of the delay pathways and serves as a common portion. In contrast, each of the expedited sub-waveguide 76 is separated from the other expedited sub-waveguide 76 and can serve as a separated portion.

Each of the expedited pathways is traveled by an expedited pathway signal that is a combination of the expedited signal and one of the expedited sub-signals. The expedited pathways and the delayed pathways are configured such that each control component 74 receives a delayed pathway signal and an expedited pathway signal that carry the same channel (the common channel). The expedited pathways and the delayed pathways can be configured such that each of the different control components 74 receives a delayed pathway signal and an expedited pathway signal that carry a different one of the common channels. Additionally, the delay pathways and the expedited pathways can be configured such that the delay pathway signal and/or the expedited pathway signal received at each of the control components 74 carries only one of the channels or carries essentially only one of the channels.

The components that define the delay pathways and the expedited pathways are configured such that an expedited pathway signal and a delayed pathway signal that arrive at the same the control component 74 have the arrival of the delayed pathway signal at the control component 74 delayed relative to the arrival of the expedited pathway signal at the control component 74.

Because the delayed pathway signal and the expedited pathway signal represent different portions of the tapped signal, each control component 74 receives a delayed portion of the tapped signal and also receives an expedited portion of the tapped signal with the delayed portion being delayed relative to the tapped portion. The components that define the delayed pathway and the expedited pathway can be configured to provide the delay between the tapped portion and the expedited portion arriving at the control component 74. For instance, the waveguides that define the delayed pathways and the waveguides that define the expedited pathways can be configured such that the delayed pathway is longer than the expedited pathway by a length that provides the delays desired at each control component 84. The length of the delay section 70 can be the primary source of the length difference between the delay pathway and the expedited pathway that lead to the same control component 74. As is evident from FIG. 2, a first delay signals that carries the different channels travel through the same delay section 70. As a result, the same delay section 70 is common to each of the delay pathways.

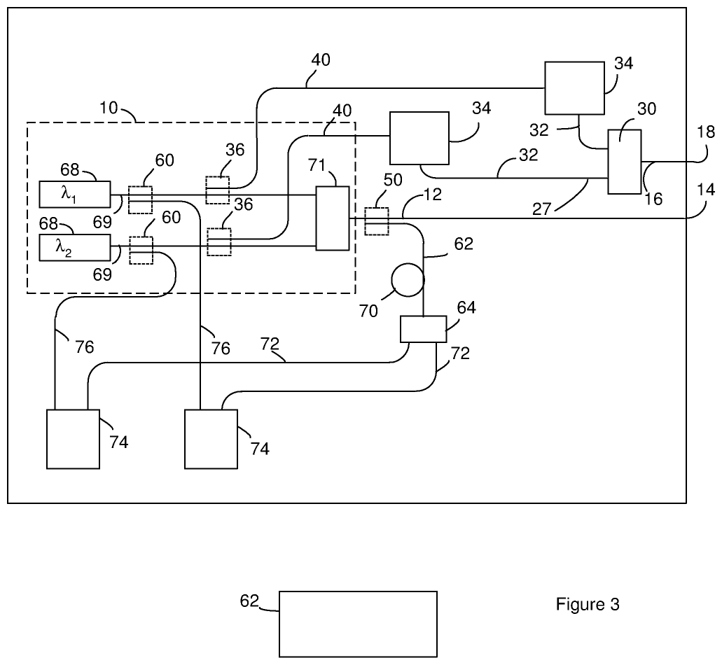

As noted above, in some instances, the second splitter 67 can be a wavelength dependent splitter configured such that the expedited sub-signals each carries a different one of the channels. Although FIG. 1A and FIG. 2 illustrate these expedited sub-signals being separated from a common signal (the expedited signal), expedited sub-signals that each carries a different one of the channels can be tapped from the source waveguides 69. For instance, FIG. 3 illustrates the LIDAR system of FIG. 1A modified to include a light source 10 constructed according to FIG. 1B. Each of the source waveguides 69 includes a splitter 60 configured to move a portion of the channel signal from a source waveguide 69 onto one of the expedited sub-waveguides 76. The portion of the channel signal received by an expedited sub-waveguide 76 serves as one of the expedited sub-signals. The expedited sub-signals each carries a different one of the channels. The expedited sub-waveguides 76 each carries one of the expedited sub-signals to one of the control components 74 as described above. Since the expedited sub-signal are not separated from the tapped signal, the delay waveguide 62 can receive the delay signal from the splitter 50 as shown in FIG. 3. For instance, the delay waveguide 62 can receive a portion of the outgoing LIDAR signal from the splitter 50. The portion of the outgoing LIDAR signal received by the delay waveguide 62 can serve as the delay signal. Suitable splitters 60 include, but are not limited to, wavelength independent splitters such as directional couplers, optical couplers, y-junctions, tapered couplers, and Multi-Mode Interference (MMI) devices.

The expedited sub-signal and the delayed channel signal received by same control component 74 each include light from the same source waveguide 69 and accordingly from the same channel signal. Light from each of the channel signals travels on one of several different delay pathways from a splitter 60 on a source waveguide 69 to one of the control components 74. Each of the delay pathways is primarily defined by the portion of a source waveguide 69 after a splitter 60, the laser multiplexer 71, the portion of the utility waveguide 12 between the laser multiplexer 71 and the splitter 50, the splitter 50, the delay waveguide 62, the first splitter 64, and one of the delayed channel waveguides 72.

Each of the delay pathways has a common portion and multiple separated portions. The common portion of each delay pathway is shared by the delay pathways. In contrast, the separated portions of a delay pathways are not shared with the other delay pathways. The light signals that travel through the common portion can carry multiple different channels. The light signals that travel through the separated portions can each carry a different channel. For instance, the portion of the utility waveguide 12 between the laser multiplexer 71 and the splitter 50, and the delay waveguide 62 are common to each of the delay pathways and serves as the common portion. In contrast, the portion of a source waveguide 69 after a splitter 60, and the delayed channel waveguides 72 are each separated from the other delayed channel waveguides 72 and serve as a separated portion.

In the LIDAR system of FIG. 3, each of the delay pathways is traveled by a delay pathway signal that is a combination of a channel signal, the outgoing LIDAR signal, the delay signal and one of the delayed channel signals. Additionally, light from each of the channel signals travels a different expedited pathway from a splitter 60 on a source waveguide 69 to one of the control components 74. The expedited pathways exclude a common portion. The expedited pathways are each defined primarily by an expedited sub-waveguide 76. Each of the expedited sub-signals serves as an expedited pathway signal that travels one of the expedited pathways.

The expedited pathways and the delayed pathways are configured such that each control component 74 receives a delayed pathway signal and an expedited pathway signal that carry the same channel (the common channel). The expedited pathways and the delayed pathways can be configured such that each of the different control components 74 receives a delayed pathway signal and an expedited pathway signal that carry a different common channel. Additionally, the delay pathways and the expedited pathways can be configured such that the delay pathway signal and/or the expedited pathway signal received at each of the control components 74 carries only one of the channels or carries essentially only one of the channels.

The components that define the delay pathways and the expedited pathways are configured such that an expedited pathway signal and a delayed pathway signal that arrive at the same the control component 74 have the arrival of the delayed pathway signal at the control component 74 delayed relative to the arrival of the expedited pathway signal at the control component 74.

Because the delayed pathway signal and the expedited pathway signal include different portions of a common signal (the channel signal), each control component 74 receives a delayed portion of the common signal and also receives an expedited portion of the common signal with the delayed portion being delayed relative to the tapped portion. The components that define the delayed pathway and the expedited pathway can be configured to provide the delay between the tapped portion and the expedited portion arriving at the control component 74. For instance, the waveguides that define the delayed pathways and the waveguide(s) that define the expedited pathways can be configured such that the delayed pathway is longer than the expedited pathway by a length that provides the delays desired at each control component 84. The length of the delay section 70 can be the primary source of the length difference between the delay pathway and the expedited pathway that lead to the same control component 74. As is evident from FIG. 3, a delay signal that carries the different channels travels through the same delay section 70. As a result, the same delay section 70 is common to each of the delay pathways and each of the channels.

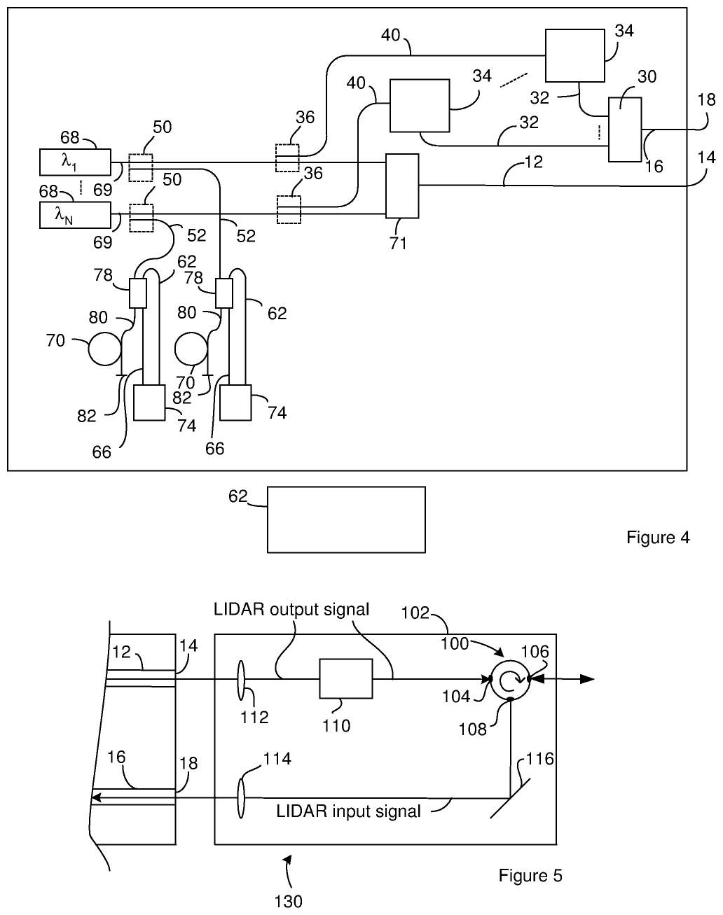

FIG. 3 illustrate a LIDAR system where the light in the expedited signals has not been separated from a common signal that carries multiple channels but the light in the delayed signals is separated from a common signal. However, the LIDAR system can be configured such that the light in the expedited signals has not been separated from a common signal and the light in the delayed signals has not been separated from a common signal. For instance, FIG. 4 illustrates the LIDAR system of FIG. 3 modified such that the light in the expedited signals and in the delayed signals has not been separated from a common signal. Each of the source waveguides 69 includes the splitter 50 and differential delay mechanism 54 disclosed in the context of FIG. 2. As a result, each of the splitters 50 is configured to move a portion of the channel signal from a source waveguide 69 onto a control waveguide 52. The portion of the channel signal received by a control waveguide 52 can serves as the tapped signal. Because each of the channel signals carries a different one of the channels, the light in each of the tapped signals carries a different one of the channels.

The tapped signals are each received at a different splitter 78. Each splitter 78 divides the tapped signal into the expedited signal and a first delayed signal. The expedited signals are each received on an expedited waveguide 66. Suitable splitters 78 include, but are not limited to, Multi-Mode Interference couplers (MMIs), and directional couplers.

Each of the first delay waveguides 80 receives the first delayed signal from the splitter 78. The first delay waveguide 80 carries the first delayed signal to a return device 82. The return device 82 is configured to return the first delayed signal to the first delay waveguide 80 such that the first delayed signal travels from the return device 82 back through the first delay waveguide 80 to the splitter 78. As a result, the first delayed signal travels through the first delay waveguide 80 twice. Each of the splitters 78 receives a first delayed signal from the first delay waveguide 80 and outputs the first delay signal on the delay waveguide 62. The portion of the first delayed signal received on the delay waveguide 62 serves as a second delay signal carried on the delay waveguide 62. A first delay signal and the associated second delay signal can effectively serve together as a delay signal.

When the channel signals each carries a single channel, the resulting first delay signal and the second delay signal also carry a single channel. As a result, the second delay signal is not a common signal and there is no need for the first splitter 64 disclosed in the context of FIG. 1A through FIG. 3. Further, since the second delay signals carry a single channel they can each effectively serve as one of the delayed channel signals disclosed in the context of FIG. 1A through FIG. 3. As a result, each of the delay waveguides 62 can serve as a delayed channel waveguides 72 from FIG. 1A through FIG. 3 by carrying a second delay signal that serves as a delayed channel signal to one of the control components 74.

When the channel signals each carries a single channel, the resulting expedited signals also carry a single channel. As a result, each of the resulting expedited signals is not a common signal and there is no need for the second splitter 67 disclosed in the context of FIG. 1A through FIG. 3. Further, since each of the expedited signals carries a single channel they can each effectively serve as one of the expedited sub-signals disclosed in the context of FIG. 1A through FIG. 3. As a result, each of the expedited waveguides 66 can serve as an expedited sub-waveguide 76 by carrying an expedited signal that serves as an expedited sub-signal to one of the control components 74.

The expedited sub-signal and the delayed channel signal received by same control component 74 each include light from the same source waveguide 69 and accordingly from the same channel signal. Light from each of the channel signals travels on one of several different delay pathways from a splitter 50 on a source waveguide 69 to one of the control components 74. Each of the delay pathways is primarily defined by a control waveguide 52, the splitter 78, a first delay waveguide 80, and a delay waveguide 62. Each of the expedited pathways and each of the delay pathways excludes a common portion.

In the LIDAR system of FIG. 4, each of the delay pathways is traveled by a delay pathway signal that is a combination of a control signal, a first delayed signal, and a second delayed signal. Additionally, light from each of the channel signals travels a different expedited pathway from a splitter 50 on a source waveguide 69 to one of the control components 74. The expedited pathways are each defined primarily by a control waveguide 52, the splitter 78, and an expedited waveguide 66. Each of the expedited pathways is traveled by an expedited pathway signal that is a combination of a control signal, the splitter 78, and an expedited sub-signal. The expedited pathways and the delayed pathways are configured such that each control component 74 receives a delayed pathway signal and an expedited pathway signal that carry the same channel. The components that define the delay pathways and the expedited pathways are configured such that an expedited pathway signal and a delayed pathway signal that arrive at the same the control component 74 have the arrival of the delayed pathway signal at the control component 74 delayed relative to the arrival of the expedited pathway signal at the control component 74.

Because the delayed pathway signal and the expedited pathway signal include different portions of a common signal (one of the channel signals), each control component 74 receives a delayed portion of the common signal and also receives an expedited portion of the common signal with the delayed portion being delayed relative to the tapped portion. The components that define the delayed pathway and the expedited pathway can be configured to provide the delay between the tapped portion and the expedited portion arriving at the control component 74. For instance, the waveguides that define the delayed pathways and the waveguide(s) that define the expedited pathways can be configured such that the delayed pathway is longer than the expedited pathway by a length that provides the delays desired at each control component 84. The length of the delay section 70 can be the primary source of the length difference between the delay pathway and the expedited pathway that lead to the same control component 74. As is evident from FIG. 4, the first delayed signals that carry the different channels travel through different delay sections 70.

In some instances, LIDAR assembly includes or consists of a LIDAR chip and a LIDAR adapter configured to separate output signals that carry light that will be exiting from the LIDAR system from return signals that have light that has already exited from the LIDAR system and returned to the LIDAR system. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the LIDAR input signal and the LIDAR output signal such that the LIDAR input signal and the LIDAR output signal travel on different optical pathways between the LIDAR adapter and the LIDAR chip but on the same optical pathway between the LIDAR adapter and a reflecting object in the field of view.

An example of a LIDAR adapter that is suitable for use with the LIDAR chip of FIG. 1A through FIG. 4 is illustrated in FIG. 5. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR assembly. As a result, the LIDAR output signal output from the LIDAR adapter and/or the LIDAR chip can serve as an assembly output signal.

The assembly output signal includes, consists of, or consists essentially of light from the LIDAR output signal received from the LIDAR chip. Accordingly, the assembly output signal may be the same or substantially the same as the LIDAR output signal received from the LIDAR chip. However, there may be differences between the assembly output signal and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in the sample region reflect the assembly output signal, at least a portion of the reflected light travels back to the circulator 100 as an assembly return signal. The assembly return signal enters the circulator 100 through the second port 106. FIG. 5 illustrates the assembly output signal traveling away from the LIDAR assembly along the same pathway that the assembly return signal traveling returns to the LIDAR assembly.

The assembly return signal exits the circulator 100 through the third port 108 and is directed to the comparative waveguide 18 on the LIDAR chip. Accordingly, all or a portion of the assembly return signal can serve as the first LIDAR input signal and the first LIDAR input signal includes or consists of light from the assembly return signal. Accordingly, the LIDAR output signal and the first LIDAR input signal travel between the LIDAR adapter and the LIDAR chip along different optical paths.

As is evident from FIG. 5, the LIDAR adapter can include optical components in addition to the circulator 100. For instance, the LIDAR adapter can include components for directing and controlling the optical path of the LIDAR output signal and the assembly return signal. As an example, the adapter of FIG. 5 includes an optional amplifier 110 positioned so as to receive and amplify the LIDAR output signal before the LIDAR output signal enters the circulator 100. The amplifier 110 can be operated by the electronics 62 allowing the electronics 62 to control the power of the LIDAR output signal. Suitable amplifiers 110 include, but are not limited to, erbium-doped fiber amplifiers (EDFA), semiconductor optical amplifiers (SOAs), and fiber amplifiers configured to operate at wavelengths other than 1550 nm such as praseodymium optical amplifiers (PDFAs).

FIG. 5 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal the on the facet 35 of the comparative waveguide 18.

The LIDAR adapter can also include one or more direction changing components such as mirrors. FIG. 5 illustrates the LIDAR adapter including a mirror as a direction-changing component 116 that redirects the assembly return signal from the circulator 100 to the facet 20 of the comparative waveguide 18.

The LIDAR chips include one or more waveguides that constrains the optical path of one or more light signals. While the LIDAR adapter can include waveguides, the optical path that the assembly return signal and the LIDAR output signal travel between components on the LIDAR adapter and/or between the LIDAR chip and a component on the LIDAR adapter can be free space. For instance, the assembly return signal and/or the LIDAR output signal can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the assembly return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers and the remaining components are discrete components.

Suitable circulators 100 for use with the adapter include, but are not limited to, the circulator disclosed in U.S. patent application Ser. No. 16/726,235, filed on Dec. 23, 2019, and entitled “LIDAR System with Separation of Signals by Polarization Angle;” and U.S. patent application Ser. No. 17/221,770, filed on Apr. 2, 2021, and entitled “Use of Circulator in LIDAR System;” each of which is incorporated herein in its entirety.

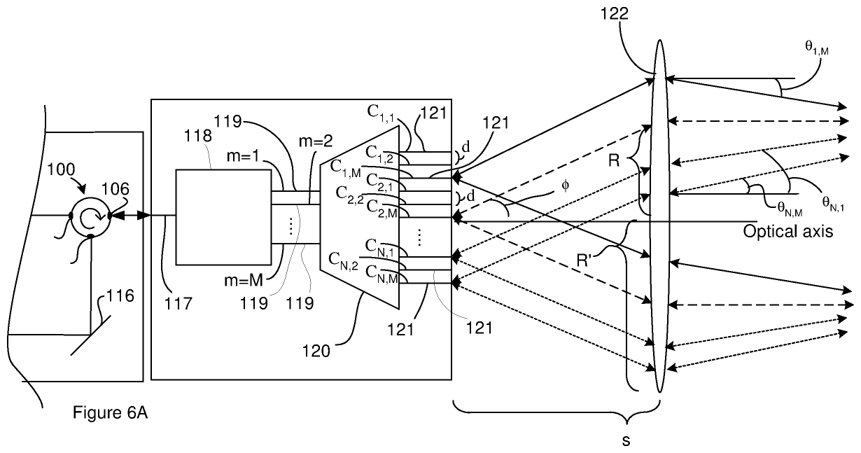

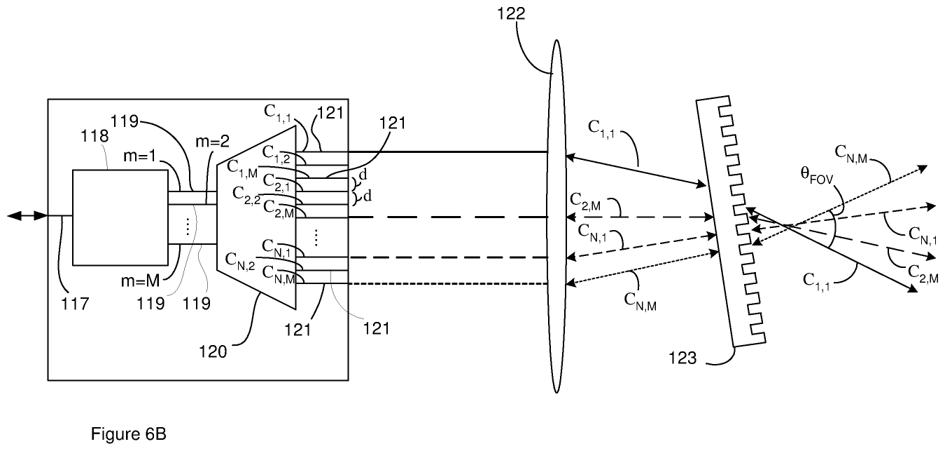

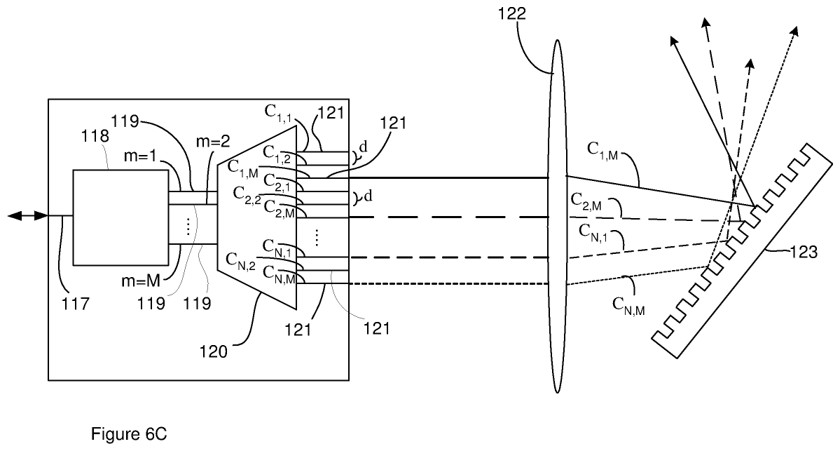

The LIDAR assembly can be used in conjunction with a scanning chip. The electronics can operate the scanning chip so as to steer the direction that system output signals travel away from the LIDAR system. The electronics can steer each of the system output signals to multiple different sample regions in a field of view. FIG. 6A is a topview of an example of a scanning chip being used with an adapter constructed according to FIG. 5. The scanning chip includes a photonic integrated circuit. The photonic integrated circuit includes a common waveguide 117 that receives the assembly output signal from the adapter. The common waveguide 117 carries the assembly output signal to an optical switch 118. Although not illustrated in FIG. 6A, other optical components, such as an amplifier, lens, or optical fiber can be positioned on the optical pathway between the circulator 106 and the optical switch 118. As a result, other optical components can operate on the assembly output signal before the assembly output signal is received at the optical switch 118. The portion of the assembly output signal received at the optical switch 118 can serve as a switch signal. The optical switch 118 directs the switch signal to a portion of multiple alternate waveguides 119. The optical switch 118 can be operated by the electronics 62. For instance, the electronics can operate the optical switch 118 so as to control which of the alternate waveguides 119 receives the switch signal. In some instances, the optical switch 118 directs the switch signal to one of multiple alternate waveguides 119. The alternate waveguides 119 are each associated with an alternate waveguide index m=1 through M.

The scanning chip includes a splitter 120 in optical communication with the alternate waveguides 119 and with multiple channel output waveguides 121. The alternate waveguides 119 can serve as first splitter waveguides and the channel output waveguides 121 can serve as second splitter waveguides. The alternate waveguide 119 that receives the switch signal guides light from the switch signal to the splitter 120. Accordingly, the splitter 120 receives the switch signal from the alternate waveguide 119 that received the switch signal from the optical switch 118. The splitter 120 is configured to divide the switch signal into multiple different channel output signals that are each received on a channel output waveguide 121. Since the switch signal includes or consists of light from the outgoing LIDAR signal, the switch signal can be a common channel that carries the multiple channels carried by the outgoing LIDAR signal. The splitter 120 can be a wavelength dependent splitter. As a result, each of the channel output signals can carry a different one of the channels. Suitable splitters 120 include, but are not limited to, demultiplexers such as arrayed waveguide gratings, echelle gratings, and ring resonator based devices.

The splitter 120 is configured such that a portion of the channel output waveguides 121 each receives one of the channel output signals. The selection of output waveguides 121 that receive one of the channel output signals can change in response to a change in which of the alternate waveguides 119 receives the switch signal. For instance, the channel output waveguides 121 in FIG. 6A are labeled C_{i,m} where i represents the channel index and m represents the alternate waveguide index. When the alternate waveguide 119 with alternate waveguide index m receives the switch signal, each of the channel output waveguides 121 in the selection of channel output waveguides 121 labeled C_{i,m} receives one of the channel output signals. As an example, when the alternate waveguide 119 with alternate waveguide index 2 receives the switch signal, each of the channel output waveguides 121 in the selection of channel output waveguides labeled C_{i,2} receives one of the channel output signals. In this example, each of the channel output waveguides 121 labeled C_{1,2}, C_{2,2}, and C_{N,2}, receives one of the channel output signals while the channel output waveguides 121 labeled C_{1,1}, C_{2,1}, C_{N,1}, C_{1,2}, C_{1,M}, C_{2,M}, and C_{N,M}, do not receive one of the channel output signals. In comparison, when the alternate waveguide 119 with alternate waveguide index M receives the switch signal, each of the channel output waveguides 121 labeled C_{i,M} receives one of the channel output signals.

Since the electronics can operate the optical switch 118 so as to control which of the alternate waveguides 119 receives the switch signal and the portion of the channel output waveguides 121 that receives one of the channel output signals changes in response to which of the alternate waveguides 119 receives the switch signal, the electronics can operate the optical switch 118 so as to control the portion of the channel output waveguides 121 receives one of the channel output signals.

The LIDAR system also includes a signal redirector configured to receive the channel output signals from any one of the channel output waveguides 121 and to direct the received channel output signals such that different channel output signals travel away from the signal redirector in different directions. Additionally, the signal redirector directs the received channel output signals such that the direction that each of the outgoing LIDAR signal travels away from the signal redirector is a function of the selection of channel output waveguides 121 from which the signal redirector receives the outgoing LIDAR signal.

The channel output signals travel away from LIDAR system in different directions as a result of the channel output signals traveling away from the signal redirector in different directions.

The different directions of the channel output signals can be a function of the channel output waveguides 121 in that the direction that the each channel output signal travels away from the signal redirector changes in responses to changes in the selection of channel output waveguide 121 from which the signal redirector receives the channel output signal. In some instances, the signal redirector is configured such that none of the different directions is parallel to one another. For instance, the signal redirector can be configured such that the different channel output signals travel away from the signal redirector at different transmission angles and the transmission angles change when the signal redirector receives the channel output signals from different channel output waveguides 121. The transmission angle is measured relative to the signal redirector.

In FIG. 6A, a lens serves as the signal redirector 122. The lens is positioned to receive the channel output signals from the channel output waveguides 121. The lens and channel output waveguides 121 are arranged such that channel output signals from different channel output waveguides 121 are incident on different regions of an input side of the lens and/or have a different incident angle on the input side of the lens. As a result, channel output signals from different channel output waveguides 121 travel away from the lens in different directions. For instance, FIG. 6A labels the transmission angle of the channel output signal that the signal redirector 122 received from the channel output waveguide 121 labeled C_{i,m} as θ_{i,m} where i represents the channel index and m represents the alternate waveguide index.

FIG. 6A labels the transmission angle label (θ_{i,m}) for the channel output signals that are output from the channel output waveguide 121 that are labeled C_{1,M}, and C_{N,M}. When the switch signal is directed to the alternate waveguide labeled m=M, the channel output signal output from the channel output waveguide 121 labeled C_{1,M} has transmission angle θ_{1,M} and the channel output signal output from the channel output waveguide 121 labeled C_{N,M} has transmission angle θ_{N,M}. Because the transmission angle θ_{1,M}, is different from the transmission angle θ_{N,M}, the signal redirector 122 can concurrently output channel output signals that carry different channels and travel away from the signal redirectors 122 in different directions.

FIG. 6A also labels the transmission angle label (θ_{i,m}) for the channel output signals that are output from the channel output waveguide 121 that are labeled C_{N,1}, and C_{N,M}. When the switch signal is directed to the alternate waveguide labeled m=1, the channel output signal carrying channel N has transmission angle θ_{N,1}. When the alternate waveguide that receives the switch signal is changed to the alternate waveguide labeled m=M, the transmission angle for the channel output signal carrying channel N changes to θ_{N,M}. As is evident from FIG. 6A, the transmission angle θ_{N,1} is different from the transmission angle θ_{N,M}. As a result, the direction that a channel output signal travels away from the signal redirector 122 changes in response to a change in the alternate waveguide that receives the switch signal.

The transmission angles are measured relative to the signal redirector 122. For instance, the transmission angle can be measured between the optical axis of the lens and the LIDAR output signal. As is evident from FIG. 6A, the angle θ_{i,m} is different for different channel output waveguides 121. Since the channel output signals from different channel output waveguides 121 travel away from the lens in different directions, the electronics can control the direction of the channel output signals by operating the switch so as to direct the switch signal to the alternate waveguide 119 that provides the channel output signals with the desired directions. The degree of change in directions from one alternate waveguide 119 to another alternate waveguide 119 can be a function of the lens construction. Accordingly, the lens construction can be altered to increase or decrease the degree of change in direction between alternate waveguides.

The LIDAR system can include an optical grating positioned to receive the channel output signals from the signal redirector. The optical grating outputs at least a portion of each one of the channel output signals received by the optical grating. The optical grating can provide additional dispersion of the channel output signals beyond the dispersion provided by the signal redirector. The level of dispersion can be selected to expand the field of view to the desired size. FIG. 6B illustrates a scanning chip used in conjunction with a signal director 122 and an optical grating 123. The optical grating 123 is positioned such that the optical pathway that each of the channel output signals travels from the splitter 120 to the optical grating 123 passes through a lens.

The optical grating 123 is positioned to receive the channel output signals from the signal redirector and to output at least a portion of each one of the channel output signals received by the optical grating. The illustrated optical grating 123 is a transmission grating. Suitable transmission gratings include, but are not limited to, ruled diffraction gratings, holographic diffraction gratings, and digital planar holographic diffraction gratings.

Each of the channel output signals has a different incident angle on the optical gating 123 and can be on a different region of the optical gating 123. Each of the channel output signals carries one of the wavelength channels (i=1 through N). Each of the channel output signals travels away from the optical grating 123 in a different direction. The direction that each of the channel output signals travels away from the optical grating changes in response to a change in the alternate waveguide to which the switch directs the switch signal. For instance, changing the alternate waveguide alternate waveguides 119 that receives the switch signal changes the channel output waveguide 121 that outputs the output signal carrying channel λᵢ. The change in the channel output waveguide 121 that outputs the output signal carrying channel λᵢ changes the angle of incidence of the output signal carrying channel λᵢ on the optical grating 123. This change in the angle of incidence changes the direction that the output signal carrying channel λᵢ travels away from the optical grating 123.

In some instances, channel output signals traveling away from the optical grating 123 are also traveling away from the LIDAR system. As a result, channel output signals that travel away from the optical grating 123 and the LIDAR system can serve as system output signals. Accordingly, each of the system output signals can travel away from the LIDAR system in a different direction and the direction that each of the system output signals travels away from the optical grating changes in response to a change in the alternate waveguide to which the switch directs the switch signal. Each of the system output signals illuminates a sample region in a field of view. As a result, the electronics can scan each of the system output signals through different sample regions in the field of view by changing the alternate waveguide 119 that receives the switch signal. The LIDAR system can be configured to generate the LIDAR data for each of the sample regions.

In some instances, the electronics delay switching the alternate waveguide 119 that receives the switch signal for a sample region illumination period with a sample region duration. As a result, the system output signals each illuminates a different sample region for the sample region duration. The sample region duration can be selected to provide the system output signals at least enough time to travel from the LIDAR system to an object at a maximum operational distance from the LIDAR system and to return to the LIDAR system.

When an object is present in a sample region that is being illuminated by a system output signal, the object can reflect light from the system output signal. The reflected light returns to the LIDAR system in a system return signal. Each of the system returns signals can carry a different one of the channels. The system return signals can be received by the optical grating 123. The optical grating 123 can be configured to output at least a portion of each system output signal. The portion of each system output signal output from the optical grating 123 can serve as a channel return signal. The optical grating 123 outputs the channel return signals such that the channel return signal carrying wavelength channel i (λᵢ) travels along the same or substantially the same path as the channel output signal carrying wavelength channel i (λᵢ) but in the reverse direction. Additionally, the channel return signal carrying wavelength channel i travels along the same or substantially the same path through the signal redirector 122 as the channel output signal carrying wavelength channel i (λᵢ) but in the reverse direction.

The scanning chip can receive channel return signals that each includes or consists of light from a different one of the system return signals. For instance, the scanning chip can receive the channel return signals from the signal redirector 122. As an example, the channel output waveguides 121 receive the channel return signal that carries the same wavelength channel as the channel output signal output from the channel output waveguide 121. For instance, during a sample region illumination period, the channel return signal carrying channel λᵢ returns to the channel output waveguide 121 that output the channel output signal carrying channel λᵢ during the sample region illumination period. Because a portion of the channel output waveguides 121 do not output a channel output signal during the sample region illumination period, a portion of the channel output waveguides 121 do not receive a channel return signal during sample region illumination period but may receive a channel return signal during a different sample region illumination period.

The channel output waveguides 121 carry the received channel return signal to the splitter 120. The splitter 120 combines the channel return signals into an assembly return signal received on the one of the alternate waveguides 119. Accordingly, the splitter 120 can operate as a demultiplexer/multiplexer. The alternate waveguide 119 that receives the assembly return signal carries the assembly return signal to the optical switch 118. The optical switch 118 guides the assembly return signal to the common waveguide 117. The common waveguide carries the assembly return signal to an exit port through which the assembly return signal can exit the scanning chip to be received by the LIDAR adapter as described above. In some instance, the exit port is a facet of the common waveguide 117.

In FIG. 6A, R represents the radius of the channel output signal at the input side of the lens, R′ represents the lens radius, and s represents the object distance from the lens. The value of R′ can be selected to increase the amount of diverging light that is captured by the lens. The ratio of R/s can be used to approximate the value needed for R′ and can be a function of the divergence angle of the light from the waveguide facet. To increase capture of the diverging light, twice the divergence half angle ϕ can be used. In that case, R/s can be at least equal to tan(2ϕ). For example, for an alternative waveguide facet dimension of 10 μm in the lateral direction, the lateral divergence half angle ϕ is approximately 6°. In that case R/s can be at least equal to tan(12°)=⅕. R′ represents the lens radius which can be larger than the half-width of the LIDAR output signal (R) to accommodate the change in position of the LIDAR output signal on the lens due to switching between the alternate waveguides. In some instances, the R′ is greater than or equal to R, 1.3R, or 1.6R and/or less than or equal to 4R, or 6R where R is greater than or equal to s*tan(2ϕ).

The center-to-center distance between the facets of the channel output waveguides 121 is labeled d in FIG. 6A. The angular resolution can be improved by decreasing d. In some instances, the center-to-center distance is constant for each adjacent pair of facets. However, the center-to-center distance can be different for different pairs of facets. A suitable center-to-center distance between facets 18 includes, but is not limited to, distances greater than 5, 10, or 50 μm and/or less than 100, 1,000, or 10,000 μm.

The maximum value for N*M can be the nearest integer value to (1+2(R′−R)/d) where R is the diameter of the channel output signals at the input side of the lens and R′ is the lens radius. Accordingly, the scanning chip can include a number of channel output waveguides 121 less than or equal to the nearest integer value of (1+2(R′−R)/d). In some instances, N*M is greater than or equal to 5, 10, or 50 and/or less than 100, 500, or 1000. The angular range that can be scanned (2θ_{N,M}) by sequentially directing the LIDAR output signal to each of the alternate waveguides 119 can be increased by increasing N or M. Accordingly, an improved resolution can be obtained by decreasing d and an improved scan range obtained by increasing N or M within the limits of the optical system.

The lens can be configured such that the lens collimates the LIDAR output signals from different channel output waveguides 121. Additionally or alternately, the lens can be positioned such that one or more of the facets is located at a focal point of the lens.

Although FIG. 6B illustrates the signal redirector 122 and the optical grating 123 positioned off the scanning chip, the signal redirector 122 can be included on the scanning chip or the optical grating 123 and signal redirector 122 can be included on the scanning chip.

Although FIG. 6C illustrates the optical grating 123 as a transmission grating, the optical grating 123 can be a reflecting grating as shown in FIG. 6C. Suitable reflective optical gratings 123 include, but are not limited to, ruled diffraction gratings, holographic diffraction gratings, and digital planar holographic diffraction gratings.

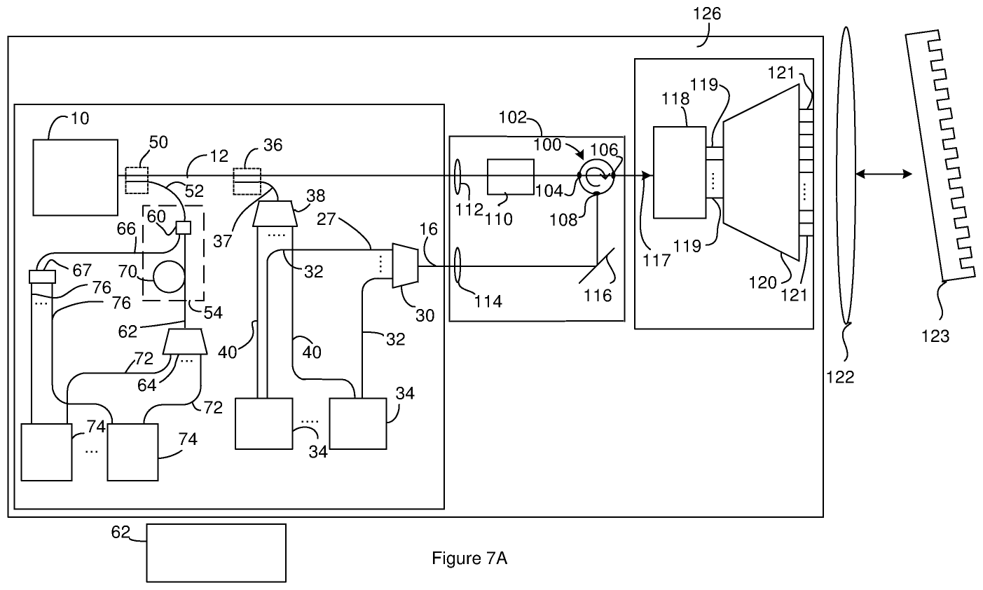

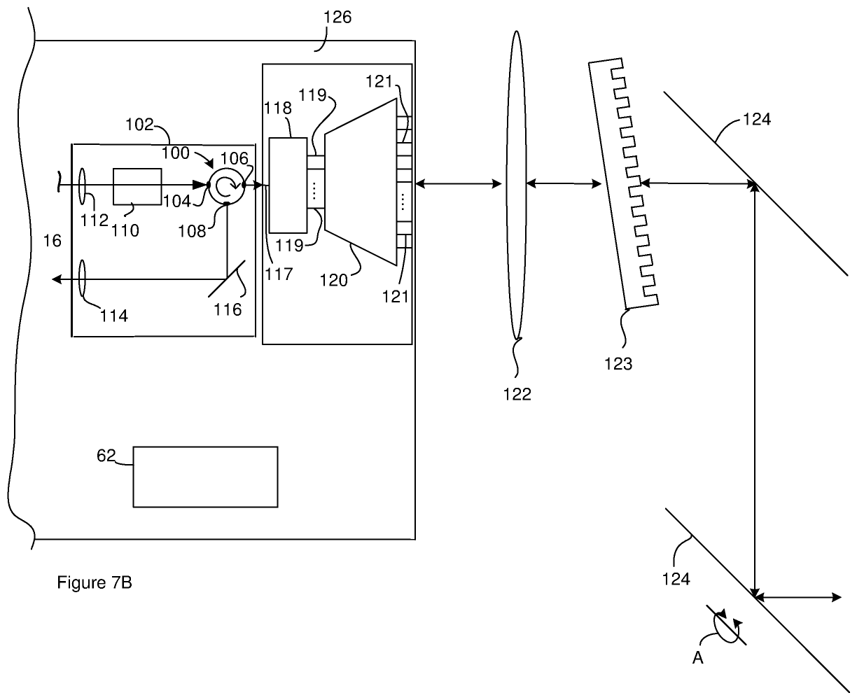

A LIDAR system can include the electronics, LIDAR chip, LIDAR adapter, scanning chip, signal redirector and optical grating. For instance, FIG. 7A is a topview of a LIDAR system that include the LIDAR chip disclosed in the context of FIG. 1A, the LIDAR adapter disclosed in the context of FIG. 5, and the scanning chip, signal redirector, and optical grating disclosed in the context of FIG. 6A. The LIDAR chip, LIDAR adapter, scanning chip, signal redirector, and optical grating can be solid-state to provide a solid-state LIDAR system.

In FIG. 6A through FIG. 6C, the channel output signals output from the optical grating 123 travel away from the LIDAR system and accordingly serve as system output signals that each carry a different one of the channels. As a result, each of the system output signals includes or consists of light from a channel output signal.

The direction that each channel output signal travels away from the optical grating 123 changes in responses to changes in the channel output waveguide 121 from which the signal redirector receives the channel output signal. As a result, the direction that each of the system output signals travels away from the LIDAR system changes in response to changes in the alternate waveguide 119 that receives the switch signal. Accordingly, the electronics can scan each of the system output signals through different sample regions in the field of view by changing the alternate waveguide 119 that receives the switch signal.

Light from the system output signals can be reflected by an object that is illuminated by a system output signal. The reflected light can travel back toward the LIDAR system as system return signals. The different system return signals each carries a different one of the channels. The system return signals received by the LIDAR system can each serve as the channel return signals.

In the LIDAR system of FIG. 6A through 7A, the channel output signals serve as system output signals; however, the LIDAR system can include one or more other components that operate on the channel output signals output from the signal redirector. Examples of components that can operate on the channel output signals output from the signal redirector include steering components. For instance, FIG. 7B is a topview of a LIDAR system that includes steering components 124 that receives the channel output signals output from the signal redirector 122 in the LIDAR system of FIG. 7A. One or more of the steering components can be operated by the electronics so as to steer the channel output signals and one or more of the steering components can be stationary. The one or more steering components 124 shown in FIG. 7B are mirrors that receive and reflect the channel output signals. The channel output signals that travel away from the one or more steering components 124 travel away from the LIDAR system and can serve as the system output signals. However, other suitable steering components include, but are not limited to stationary and/or steerable optical gratings and solid-state steering devices.

In FIG. 7B, one of the steering components 124 is stationary and one of the steering components 124 is movable. The movable steering component can be operated by the electronics so as to steer the channel output signals within the field of view. For instance, as illustrated by the arrows labeled A in FIG. 7B, the electronics can control movement of one or more of the steering components 124 so as to steer the system output signals within the field of view. The electronics can operate the one or more of the steering components 124 so as to steer the system output signals outside of the field of view provided only by operation of the optical switch. For instance, the operation of the optical switch can steer movement of the system output signals in what is substantially a two-dimensional or planar field of view. In contrast, the electronics can operate the one or more steering components 124 so as to steer channel output signals outside of the substantially two-dimensional steering provided by the optical switch 118. As a result, the electronics can operate the optical switch 118 and one or more steering components 124 so as to steer the system output signals to sample regions in a three-dimensional field of view.

The rate of scanning provided by operation of the scanning switch can be higher than the rate of scanning provided by the one or more steering components 124. For instance, the rate of scanning provided by operation of the scanning switch can at least 5, 10, or 100 times higher than the rate of scanning provided by the one or more steering components 124. The rate of scanning can be the angular rate of change of all or a portion of the system output signals. For instance, the rate of scanning provided by operation of the scanning switch can be the average rate of change of the transmission angle of all or a portion of the system output signals that results from operation of the scanning switch.

Light can be reflected by an object that is illuminated by a system output signal. The reflected light can travel back toward the LIDAR system and can accordingly serve as system return signal. The different system return signals each carry a different one of the channels. The system return signals received by the LIDAR system can serve as the channel return signals. For instance, each of the system returns signal received by the one or more steering components 124 can serve as one of the channel return signals.

The LIDAR systems of FIG. 7A and FIG. 7B show the LIDAR chip, electronics, LIDAR adapter, and scanning chip positioned on a common support 126. Although the electronics 62 are illustrated as being located on the common support 126, all or a portion of the electronics can be located off the common support 126. FIG. 7B show the signal redirector 122 and the one or more steering components 124 positioned off of the common support 126; however, one or more components selected from the group consisting of the signal redirector 122 and the one or more steering components 124 can be positioned on the common support 126. Suitable approaches for mounting components such as the LIDAR chip, electronics, scanning chip, LIDAR adapter, signal redirector and the one or more steering components on a common support include, but are not limited to, epoxy, solder, and mechanical clamping.

Although FIG. 7A and FIG. 7B illustrate the components of the LIDAR adapter positioned on a base 102 and the base positioned on the common support 126, all or a portion of the components for the LIDAR adapter can be positioned on the common support 126. As a result, the base 102 is optional.

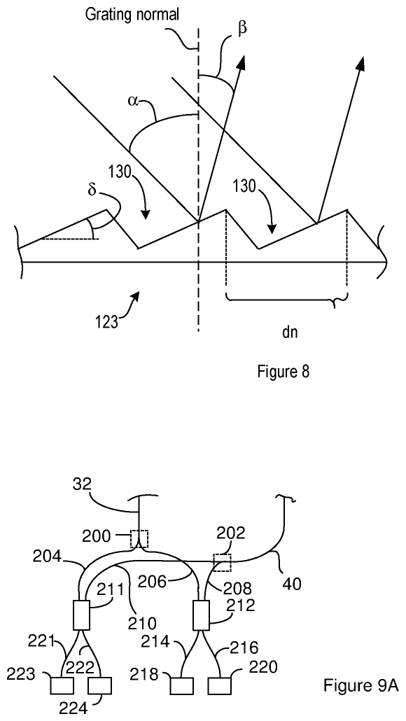

FIG. 8 illustrates a portion of a suitable reflective optical grating 123 that includes multiple grooves 130. The level of dispersion for the optical grating 123 is a measure of the degree to which different channels separate as they travel away from the grating and can be expressed as dβ/dλ where λ represents wavelength and β represents the angle of reflection as shown in FIG. 8. At the wavelengths and distances used in many LIDAR applications, suitable dispersion levels include, but are not limited to, dispersion levels greater than 0.05°/nm, or 0.1°/nm and/or less than 0.15°/nm, or 0.2° nm. The level of dispersion increases with increasing grating order, decreasing grating spacing (labeled dn in FIG. 8), and increasing angle of incidence (α). Additionally, the grating efficiency increases as the blaze angle (labeled δ) increases. In some instances, the grating has all or a portion of the features selected from the group consisting of an order greater than 10, 20, or 50 and/or less than 100, 200, or 300; a grating spacing (dn) greater than 5 μm, 10 μm, or 20 μm and/or less than 25 μm, 30 μm, or 40 μm; an angle of incidence maintained in a range of 40° to 60° or 20° to 40°; a blaze angle greater than 10°, 20°, or 30° and/or less than 40°, 50°, or 60°; and receives a LIDAR input signal carrying multiple channels having wavelengths less than 1640 nm, 1600 nm, or 1550 nm and greater than 1450 nm, 1350 nm, or 1250 nm. In one example, the grating has an order of 20; a grating spacing (d) of 21 μm; an angle of incidence of 40°; a blaze angle (δ) of 48°; receives a LIDAR input signal carrying multiple channels having wavelengths less than 1570 nm and greater than 1538 nm.

The number of wavelength channels (N), the center-to-center distance between the facets of the channel output waveguides (d), and the dispersion are selected to provide the desired sample region scan rate, angular resolution, and field of view with the desired dimensions. The dimensions of the field of view (FOV) can often be indicated by an FOV angle (labeled θ_{FOV} in FIG. 6B) that indicates the total angular range over which the system output signals are scanned during a scan of the field of view. In some instances, the FOV angle (θ_{FOV}) can be represented by the angular difference between the system output signals carrying C_{1,1} and C_{N,M} as show in FIG. 6B. An FOV angle greater than 25°, and a scan rate of between 2 and 2.5 million sample regions/per second, can be achieved using at least 16 wavelength channels (N≥16) when the center-to-center distance between the facets of the channel output waveguides (d) is less than 100 μm and greater than 5 μm, the dispersion of the optical grating is 0.1 degrees/nm, and the wavelength of the at least 16 system output signals is in a range of 1535 nm to 1565 nm.

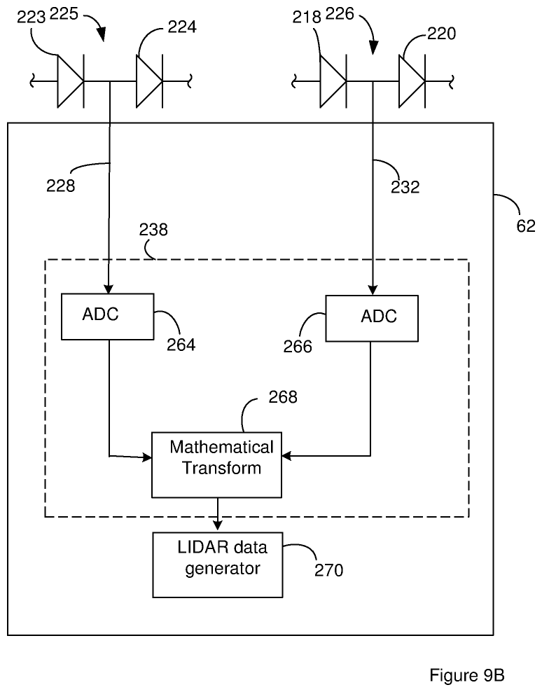

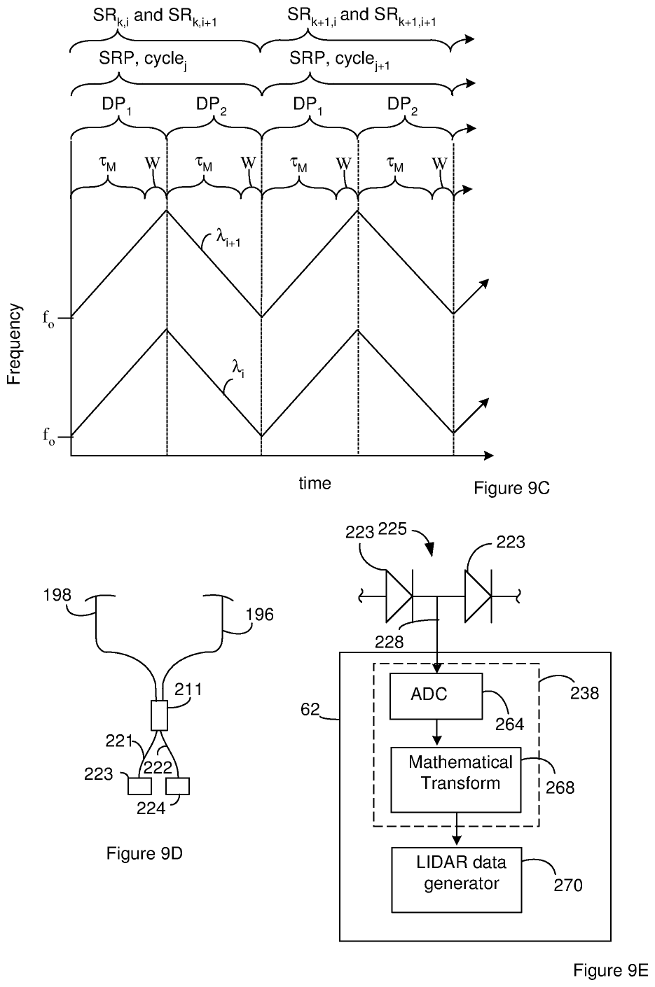

FIG. 9A through FIG. 9C illustrate an example of a suitable processing component for use as all or a fraction of the processing components 34. The processing component 34 receives a comparative signal from one of the comparative waveguide 32 and a reference signal from one of the reference waveguides 40. The processing component includes a second splitter 200 that divides the comparative signal carried on the comparative waveguide 32 onto a first comparative waveguide 204 and a second comparative waveguide 206. The first comparative waveguide 204 carries a first portion of the comparative signal to the light-combining component 211. The second comparative waveguide 208 carries a second portion of the comparative signal to the second light-combining component 212.

The processing component includes a first splitter 202 that divides the reference signal carried on the reference waveguide 40 onto a first reference waveguide 204 and a second reference waveguide 206. The first reference waveguide 204 carries a first portion of the reference signal to the light-combining component 211. The second reference waveguide 208 carries a second portion of the reference signal to the second light-combining component 212.

The second light-combining component 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second light-combining component 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light-combining component 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light-combining component 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light-combining component 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first light-combining component 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light-combining component 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light-combining component 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light-combining component 212 splits the second composite signal such that the portion of the comparative signal in the first portion of the second composite signal is phase shifted by 180° relative to the portion of the comparative signal in the second portion of the second composite signal, the light-combining component 211 also splits the composite signal such that the portion of the comparative signal in the first portion of the composite signal is phase shifted by 180° relative to the portion of the comparative signal in the second portion of the composite signal. When the second light-combining component 212 splits the second composite signal such that the portion of the reference signal in the first portion of the second composite signal is phase shifted by 180° relative to the portion of the reference signal in the second portion of the second composite signal, the light-combining component 211 also splits the composite signal such that the portion of the reference signal in the first portion of the composite signal is phase shifted by 180° relative to the portion of the reference signal in the second portion of the composite signal.

Suitable light-combining components 211 and second light-combining components 212 include, but are not limited to, Multi-Mode Interference couplers, directional couplers, and tapered couplers.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90 degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. For instance, FIG. 9B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 9B are included on the LIDAR chip. In some instances, the components illustrated in the schematic of FIG. 9B are distributed between the LIDAR chip and electronics located off of the LIDAR chip.

The electronics 62 connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 62 includes a transform mechanism 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The transform mechanism 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The transform mechanism 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The transform mechanism 238 includes a mathematical transformer 268 that receives the complex data signal. For instance, the mathematical transformer 268 receives the first digital data signal from the first Analog-to-Digital Converter (ADC) 264 as an input and also receives the second digital data signal from the second Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip.

The mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal. The mathematical transformer 268 can execute the attributed functions using firmware, hardware or software or a combination thereof.

The data processor 237 includes a LIDAR data generator 270 that receives the beat frequency of the composite signal from the peak finder. The LIDAR data generator 270 processes the beat frequency of the composite signal so as to generate the LIDAR data (distance and/or radial velocity between the reflecting object and the LIDAR chip or LIDAR system).

FIG. 9C shows an example of a relationship between the frequency of the system output signal(s), time, cycles and data periods. The frequency versus time pattern is shown for two of the system output signals carrying different channels. The system output signal carrying channel i is labeled λᵢ where i represents the channel index. The base frequency of the system output signal (fₒ) can be the lowest frequency of the system output signal during a cycle.

The frequency versus time patterns are shown for a sequence of two cycles labeled cycleⱼ and cycleⱼ₊₁. In some instances, the frequency versus time pattern is repeated in each cycle as shown in FIG. 9C.

Each cycle includes K data periods that are each associated with a period index k and are labeled DPₖ. In the example of FIG. 9C, each cycle includes two data periods labeled DPₖ with k=1 and 2. In some instances, the frequency versus time pattern is the same for the data periods that correspond to each other in different cycles as is shown in FIG. 9C. Corresponding data periods are data periods with the same period index. As a result, each data period DP₁ can be considered corresponding data periods and the associated frequency versus time patterns are the same in FIG. 9C. At the end of a cycle, the electronics return the frequency to the same frequency level at which it started the previous cycle.

During the data period DP₁, and the data period DP₂, the electronics operate the light source that generates the channel signal carrying channel λᵢ such that the frequency of the system output signal changes at a linear rate αᵢ where i represents the channel index. The direction of the frequency change during the data period DP₁ is the opposite of the direction of the frequency change during the data period DP₂.

During each cycle, the system output signal that carries channel i illuminates a sample region labeled SR_{k,i} where k represents a sample region index and i represents the channel index. For instance, during the cycle labeled j in FIG. 9C, the sample region SR_{k,i} is illuminated by the system output signal carrying channel λᵢ and the sample region SR_{k,i+1} is illuminated by the system output signal carrying channel λᵢ₊₁. The sample region indices k can be assigned relative to time. For instance, the samples regions can be illuminated by the system output signal in the sequence indicated by the index k. As a result, the sample region SR_{10,1} can be illuminated after sample region SR_{9,1} and before SR_{11,1}.

The sample region illumination periods are labeled SRP and can be the same as the time of each cycle. As a result, the sample region duration can be the same as the duration of each cycle. In some instances, the electronics do not switch the alternate waveguide 119 that receives the switch signal during the sample region illumination period. As a result, during each sample region illumination period, the system output signals do not move in response changes to the alternate waveguide 119 that receives the switch signal.

In some instances, moving the system output signals to different sample regions includes changing the alternate waveguide 119 that receives the switch signal. The change in the alternate waveguide 119 that receives the switch signal can be done in between cycles. In some instances, there may be a delay associated with changing the alternate waveguide 119 that receives the switch signal. Although that delay may be present, that delay is not illustrated in FIG. 9C.

When the electronics operate one or more steering components 124 to steer the system output signals in the field of view, the steering of the system output signals by the one or more steering components 124 can be continuous. This continuous movement is a contrast to the stop-and-go movement provided by changing the alternate waveguide 119 that receives the switch signal.

The LIDAR system is typically configured to provide reliable LIDAR data when the object is within an operational distance range from the LIDAR system. The operational distance range can extend from a minimum operational distance to the maximum operational distance. A maximum roundtrip time can be the time required for a system output signal to exit the LIDAR system, travel the maximum operational distance to the object, and to return to the LIDAR system and is labeled τ_{M} in FIG. 9C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a beat frequency, the electronics measure the beat frequency that results from system return signal that return to the LIDAR system during a data window in the data period. The data window is labeled “W” in FIG. 9C. The contribution from the LIDAR signal to the composite signals will be present at times larger than the maximum operational time delay (τ_{M}). As a result, the data window is shown extending from the maximum operational time delay (τ_{M}) to the end of the data period.

FIG. 9C illustrates the frequency versus time pattern for two channels, however, the frequency versus time pattern disclosed in the context of FIG. 9C can be applied to each of the channels.

As is evident from the above discussion, each processing component 34 receives a comparative signal and a reference signal carrying the same channel. As a result, the frequency output from the Complex Fourier transform associated with a processing component 34 represents the beat frequency of a composite signal that includes a comparative signal beating against a reference signal where the comparative signal and the reference signal carry the same channel. The beat frequencies from the same processing component 34 and from two or more different data periods can be combined to generate the LIDAR data for one of the sample regions. For instance, the processing component 34 that receives the comparative signal and reference signal carrying channel λᵢ can combine the beat frequency generated from DP₁ in cycle j with the beat frequency generated from DP₂ in cycle j to generate the LIDAR data for the sample region SR_{k,i}. As an example, the following equation applies during a data period where electronics increase the frequency of the outgoing LIDAR signal during the data period such as occurs in data period DP₁ of FIG. 9C: f_{ub}=−f_{d}+αₖτ where f_{ub} is the frequency provided by the mathematical transformer 268, f_{d} represents the Doppler shift (f_{d}=2νf_{c}/c) where f_{c} represents the base frequency (fₒ), c represents the speed of light, ν is the radial velocity between the reflecting object and the LIDAR system where the direction from the reflecting object toward the LIDAR system is assumed to be the positive direction, c is the speed of light, and τ represents the time for the system output signal to exit from the LIDAR system, be reflected by an object located outside of the LIDAR system and the reflected light to return the LIDAR system in a system return signal (the roundtrip time). Additionally, αₖ represents the chirp rate during the data period with period index k. For instance, α₁ represents the chirp rate during the same data period DP₁ that resulted in the f_{ub} being provided by the mathematical transformer. As a result, αₖ and f_{ub} are associated with the same data period DPₖ.

The following equation applies during a data period where electronics decrease the frequency of the outgoing LIDAR signal such as occurs in data period DP₂ of FIG. 9C: f_{db}=−f_{d}−αₖ*τ where f_{db} is a frequency provided by the mathematical transformer 268. In these two equations, f_{d} and τ are unknowns. In these two equations (f_{db}=−f_{d}−αₙτ and f_{ub}=−f_{d}+αₙτ), f_{d} and τ are unknowns. These equations can be solved for these two unknowns. The LIDAR data generator can calculate the radial velocity for the sample region from the Doppler shift (ν=c*f_{d}/(2f_{c})) and/or the separation distance for that sample region from c*τ/2. For instance, when the system output signal has a frequency versus time pattern as shown in FIG. 9C, the distance between the LIDAR system and an object external to the LIDAR system (r) can be calculated from r=c(f_{ub}−f_{db})/(2(α₁−α₂)) and the radial velocity between the LIDAR system and the object can be calculated from ν=c(α₂f_{ub}−α₁f_{db})/(2f_{c}(α₁−α₂)). The resulting LIDAR data (r and/or ν) represent the LIDAR data for the sample region illuminated by the system output signal carrying channel λᵢ. Since multiple different sample regions can be concurrently illuminated by system output signal carrying different channels, the LIDAR data can be generated for each of the different sample regions that are concurrently illuminated by one of the system output signals. Additionally, the different LIDAR data results can be generated in parallel using different processing component 34. Alternately, the different LIDAR data results can be generated in series using different processing component 34 depending on the configuration of the electronics.

In some instances, more than one object is present in a sample region. In some instances when more than one object is present in a sample region, the transform may output more than one frequency where each frequency is associated with a different object. The frequencies that result from the same object in different data periods of the same cycle can be considered corresponding frequency pairs. LIDAR data can be generated for each corresponding frequency pair output by the transform. As a result separate LIDAR data can be generated for each of the objects in a sample region.

Although FIG. 9A through FIG. 9B illustrate light-combining components that combine a portion of the reference signal with a portion of the comparative signal, the processing component can include a single light-combining component that combines the reference signal with the comparative signal so as to form a composite signal. As a result, at least a portion of the reference signal and at least a portion of the comparative signal can be combined to form a composite signal. The combined portion of the reference signal can be the entire reference signal or a fraction of the reference signal and the combined portion of the comparative signal can be the entire comparative signal or a fraction of the comparative signal.

As an example of a processing component that combines the reference signal and the comparative signal so as to form a composite signal, FIG. 9D through FIG. 9E illustrate the processing component of FIG. 9A through FIG. 9B modified to include a single light-combining component. The comparative waveguide 196 carries the comparative signal directly to the first light-combining component 211 and the reference waveguide 198 carries the reference signal directly to the first light-combining component 211.

The first light-combining component 211 combines the comparative signal and the reference signal into a composite signal. Due to the difference in frequencies between the comparative signal and the reference signal, the first composite signal is beating between the comparative signal and the reference signal. The first light-combining component 211 also splits the composite signal onto the first detector waveguide 221 and the second detector waveguide 222. The first detector waveguide 221 carries a first portion of the composite signal to the first light sensor 223 that converts the first portion of the second composite signal to a first electrical signal. The second detector waveguide 222 carries a second portion of the composite signal to the second light sensor 224 that converts the second portion of the second composite signal to a second electrical signal.

FIG. 9E provides a schematic of the relationship between the electronics, the first light sensor 223, and the second light sensor 224. The symbol for a photodiode is used to represent the first light sensor 223, and the second light sensor 224 but one or more of these sensors can have other constructions. In some instances, all of the components illustrated in the schematic of FIG. 9E are included on the LIDAR chip. In some instances, the components illustrated in the schematic of FIG. 9E are distributed between the LIDAR chip and electronics located off of the LIDAR chip.

The electronics connect the first light sensor 223 and the second light sensor 224 as a first balanced detector 225. In particular, the first light sensor 223 and the second light sensor 224 are connected in series. The serial connection in the first balanced detector is in communication with a first data line 228 that carries the output from the first balanced detector as a first data signal. The first data signal is an electrical representation of the composite signal.

The electronics 62 include a transform mechanism 238 configured to perform a mathematical transform on the first data signal. The mathematical transform can be a real Fourier transform with the first data signal as an input. The LIDAR data generator 270 can use the frequency output from the transform as described above to extract the LIDAR data.

Each of the balanced detectors disclosed in the context of FIG. 9A through FIG. 9E can be replaced with a single light sensor. As a result, the processing component can include one or more light sensors that each receives at least a portion of a composite signal in that the received portion of the composite signal can be the entire composite signal or a fraction of the composite signal.

As discussed in the context of FIG. 9C, the electronics 62 tune the frequency of the system output signal. One method to produce this frequency chirp is to modulate the electrical current applied to the light source by the electronics. In semiconductor lasers that can be used as the light source in the LIDAR system, current modulation results in frequency modulation via strong nonlinear carrier/photon coupling.

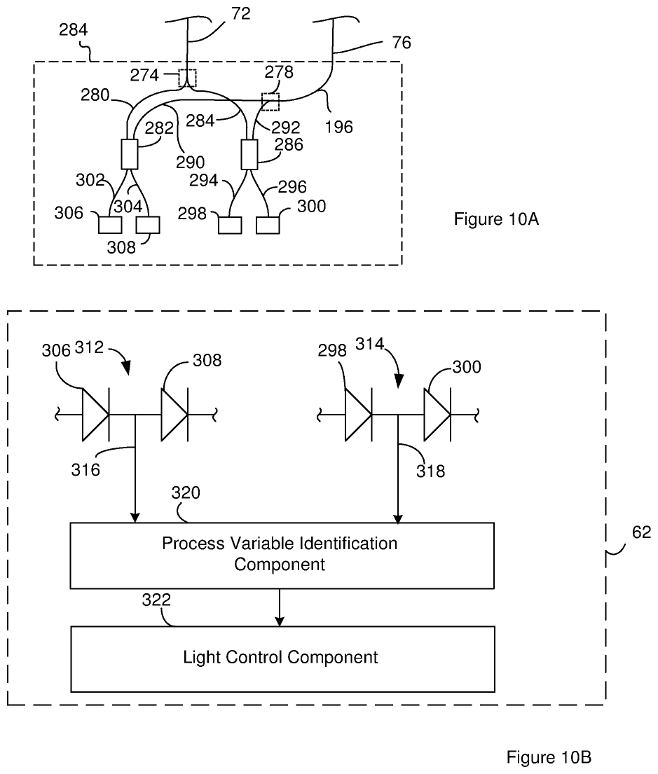

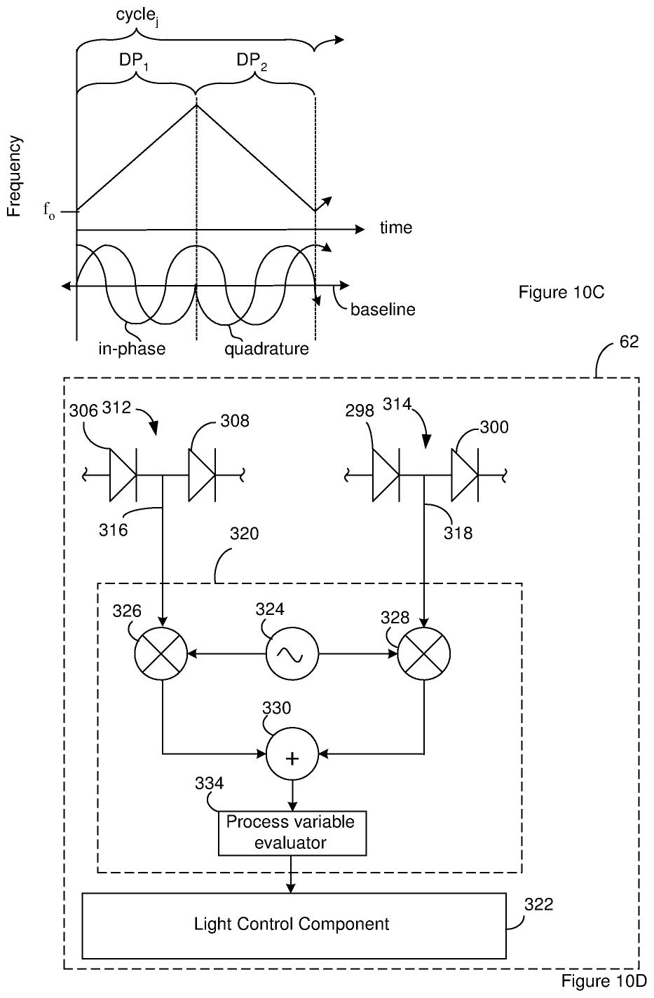

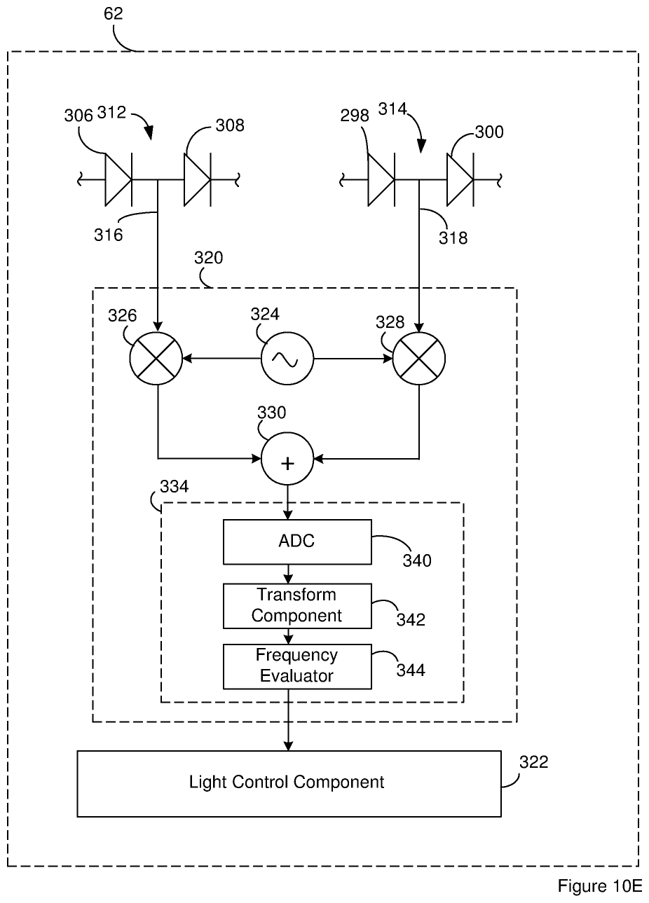

FIG. 10A and FIG. 10B illustrate an example of a suitable control component for use as all or a fraction of the control component 74 disclosed in the context of FIG. 1A through FIG. 4. As discussed above, each of the control component 74 receives a delay pathway signal from a delayed channel waveguide 72 and a delay pathway signal from a delayed channel waveguide 72 and an expedited pathway signal from an expedited sub-waveguide 76. The delay pathway signal and the expedited pathway signal received at a control component 74 carry the same channel labeled λᵢ.

The delayed channel waveguide 72 carries the delayed pathway signal to a first splitter 274. The expedited sub-waveguide 76 carries the expedited pathway signal to a second splitter 278. Suitable splitters for uses as the first splitter 274 and the second splitter 278 include, but are not limited to, wavelength independent splitters such as directional couplers, optical couplers, y-junctions, tapered couplers, and Multi-Mode Interference (MMI) devices.

The first splitter 274 divides the delayed pathway signal into a first portion of a delayed signal and a second portion of a delayed signal. A first delayed waveguide 280 carries the first portion of the delayed signal to a first light-combining component 282. A second delayed waveguide 284 carries the second portion of the delayed signal to a second light-combining component 286.

The second splitter 278 divides the expedited signal into a first portion of an expedited signal and a second portion of an expedited signal. A first expedited waveguide 290 carries the first portion of the expedited signal to the first light-combining component 282. A second expedited waveguide 292 carries the second portion of the expedited signal to the second light-combining component 286.

The first light-combining component 282 combines the first portion of the expedited signal and the first portion of the delayed signal into a first beating signal. Additionally, the second light-combining component 286 combines the second portion of the expedited signal and the second portion of the delayed signal into a second beating signal. As a result, each of the delayed pathways extends from a splitter to a light-combiner that combines light from one of the delayed pathway signals with light from one of the expedited pathway signals.

As noted above, the length of the delay pathway exceeds the length of the expedited pathway. As a result, the second portion of the delayed signal is delayed relative to the second portion of the expedited signal. Because the electronics can tune the frequency of the outgoing LIDAR signal, the delay causes the second portion of the delayed signal to have a different frequency than the second portion of the expedited signal. Due to the difference in frequencies between the second portion of the expedited signal and the second portion of the delayed signal, the second beating signal is beating between the second portion of the expedited signal and the second portion of the delayed signal.

The second light-combining component 286 also splits the second beating signal onto a first auxiliary detector waveguide 294 and a second auxiliary detector waveguide 296. The first auxiliary detector waveguide 294 carries a first portion of the second beating signal to a first auxiliary light sensor 298 that converts the first portion of the second beating signal to a first auxiliary electrical signal. The second auxiliary detector waveguide 296 carries a second portion of the second beating signal to a second auxiliary light sensor 300 that converts the second portion of the second beating signal to a second auxiliary electrical signal. Examples of suitable light sensors include germanium photodiodes (PDs), and avalanche photodiodes (APDs).

In some instances, the second light-combining component 286 splits the second beating signal such that the portion of the expedited signal (i.e. the portion of the second portion of the expedited signal) included in the first portion of the second beating signal is phase shifted by 180° relative to the portion of the expedited signal (i.e. the portion of the second portion of the expedited signal) in the second portion of the second beating signal but the portion of the delayed signal (i.e. the portion of the second portion of the delayed signal) in the second portion of the second beating signal is not phase shifted relative to the portion of the delayed signal (i.e. the portion of the second portion of the delayed signal) in the first portion of the second beating signal.

As noted above, the length of the delay pathway exceeds the length of the expedited pathway. As a result, the first portion of the delayed signal is delayed relative to the first portion of the expedited signal. The delay causes the first portion of the delayed signal to have a different frequency than the first portion of the expedited signal. Due to the difference in frequencies between the first portion of the expedited signal and the first portion of the delayed signal, the first beating signal is beating between the second portion of the expedited signal and the second portion of the delayed signal.

The first light-combining component 282 also splits the first beating signal onto a first detector waveguide 302 and a second detector waveguide 304. The first detector waveguide 302 carries a first portion of the first beating signal to a first light sensor 306 that converts the first portion of the second beating signal to a first electrical signal. The second detector waveguide 304 carries a second portion of the second beating signal to a second light sensor 308 that converts the second portion of the second beating signal to a second electrical signal. Examples of suitable light sensors include germanium photodiodes (PDs), and avalanche photodiodes (APDs).

In some instances, the first light-combining component 282 splits the first beating signal such that the portion of the expedited signal (i.e. the portion of the first portion of the expedited signal) included in the first portion of the beating signal is phase shifted by 180° relative to the portion of the expedited signal (i.e. the portion of the first portion of the expedited signal) in the second portion of the beating signal but the portion of the delayed signal (i.e. the portion of the first portion of the delayed signal) in the first portion of the beating signal is not phase shifted relative to the portion of the delayed signal (i.e. the portion of the first portion of the delayed signal) in the second portion of the beating signal.

When the second light-combining component 286 splits the second beating signal such that the portion of the expedited signal in the first portion of the second beating signal is phase shifted by 180° relative to the portion of the expedited signal in the second portion of the second beating signal, the first light-combining component 282 also splits the beating signal such that the portion of the expedited signal in the first portion of the beating signal is phase shifted by 180° relative to the portion of the expedited signal in the second portion of the beating signal.

The first delayed waveguide 280, the second delayed waveguide 284, the first expedited waveguide 80, and the second expedited waveguide 292 can be configured such that the first beating signal and the second beating signal together act as an in-phase component and quadrature component of an optical process variable signal where the first beating signal is the in-phase component of the optical process variable signal and the second beating signal is the quadrature component of the optical process variable signal or such that the second beating signal is the in-phase component of the optical process variable signal and the first beating signal is the quadrature component of the optical process variable signal. For instance, the first delayed waveguide 280 and the second delayed waveguide 284 can be constructed to provide a phase shift between the first portion of the delayed signal and the second portion of the delayed signal while the first expedited waveguide 80 and the second expedited waveguide 292 are constructed such that the first portion of the expedited signal and the second portion of the expedited signal are in phase. As an example, the first delayed waveguide 280 and the second delayed waveguide 284 can be constructed so as to provide a 90° phase shift between the first portion of the delayed signal and the second portion of the delayed signal. Accordingly, one of the delayed signal portions can be a sinusoidal function and the other delayed signal portion can be a cosine function operating on the same argument as the sinusoidal function. In one example, the first delayed waveguide 280 and the second delayed waveguide 284 are constructed such that the first portion of the delayed signal is a cosine function and the second portion of the delayed signal is a sine function. In this example, the portion of the delayed signal in the second beating signal is phase shifted relative to the portion of the delayed signal in the first beating signal, however, the portion of the expedited signal in the first beating signal is not phase shifted relative to the portion of the expedited signal in the second beating signal.

In another example, the first delayed waveguide 280 and the second delayed waveguide 284 are constructed such that the first portion of the delayed signal and the second portion of the delayed signal are in phase while the first expedited waveguide 80 and the second expedited waveguide 292 are constructed to provide a phase shift between the first portion of the expedited signal and the second portion of the expedited signal. As an example, the first expedited waveguide 80 and the second expedited waveguide 292 can be constructed so as to provide a 90° phase shift between the first portion of the expedited signal and the second portion of the expedited signal. Accordingly, one of the expedited signal portions can be a sinusoidal function and the other expedited signal portion can be a cosine function operating on the same argument as the sinusoidal function. In one example, the first expedited waveguide 80 and the second expedited waveguide 292 are constructed such that the first portion of the expedited signal is a cosine function and the second portion of the expedited signal is a sine function operating on the same argument as the cosine function. In this example, the portion of the expedited signal in the second beating signal is phase shifted relative to the portion of the expedited signal in the first beating signal, however, the portion of the delayed signal in the first beating signal is not phase shifted relative to the portion of the delayed signal in the second beating signal.

The first light sensor 306 and the second light sensor 308 can be connected as a balanced detector and the first auxiliary light sensor 298 and the second auxiliary light sensor 300 can also be connected as a balanced detector. For instance, FIG. 10B provides a schematic of the relationship between the electronics 62, the first light sensor 306, the second light sensor 308, the first auxiliary light sensor 298, and the second auxiliary light sensor 300. The symbol for a photodiode is used to represent the first light sensor 306, the second light sensor 308, the first auxiliary light sensor 298, and the second auxiliary light sensor 300 but one or more of these sensors can have other constructions. In some instances, all of the components illustrated in the schematic of FIG. 10B are included on the LIDAR chip. In some instances, the components illustrated in the schematic of FIG. 10B are distributed between the LIDAR chip and electronics located off of the LIDAR chip.

The electronics 62 connect the first light sensor 306 and the second light sensor 308 as a first balanced detector 312 and the first auxiliary light sensor 298 and the second auxiliary light sensor 300 as a second balanced detector 314. In particular, the first light sensor 306 and the second light sensor 308 are connected in series. Additionally, the first auxiliary light sensor 298 and the second auxiliary light sensor 300 are connected in series. The serial connection in the first balanced detector is in communication with a first data line 316 that carries the output from the first balanced detector as a first process variable signal. The serial connection in the second balanced detector is in communication with a second data line 318 that carries the output from the second balanced detector as a second process variable signal.

The first process variable signal is an electrical representation of the first beating signal and the second process variable signal is an electrical representation of the second beating signal. Accordingly, the first process variable signal is beating and the second process variable signal is beating. Additionally, the first process variable signal and the second process variable signal can each carry a different one of the components selected from a group consisting of the in-phase component of a process variable signal and the quadrature component of the process variable signal. For instance, the first process variable signal can include a contribution from a first waveform and a second waveform and the second process variable signal can include a contribution from the first waveform and the second waveform. The portion of the first waveform in the first process variable signal is phase-shifted relative to the portion of the first waveform in the second process variable signal but the portion of the second waveform in the first process variable signal is in-phase relative to the portion of the second waveform in the second process variable signal. For instance, the second process variable signal can include a portion of the delayed signal that is phase shifted relative to a different portion of the delayed signal that is included the first process variable signal. Additionally, the second process variable signal can include a portion of the expedited signal that is in-phase with a different portion of the expedited signal that is included in the first process variable signal. The first process variable signal and the second process variable signal are each beating as a result of the beating between the expedited signal and the delayed signal, i.e. the beating in the first beating signal and in the second beating signal.

The electronics 62 include a process variable identification component 320 that receives the process variable signal. The process variable identification component 320 uses the process variable signal to output an indicator signal that indicates, is a function of, and/or can be used to determine the frequency of the channel signal (f_{CS}) that carries the channel received by the control component 74 that includes the process variable identification component 320. In some instances, the indicator signal is an analog signal with one or more characteristics that are related to the frequency of the channel signal (f_{CS}). In some instances, the indicator signal is a digital signal that quantifies the frequency of the channel signal (f_{CS}), is related to the frequency of the channel signal (f_{CS}), or can be used to quantify the frequency of the channel signal (f_{CS}). Because a system output signal carrying channel λᵢ is a portion of the channel LIDAR signal carrying channel λᵢ, the frequency of the channel signal can represent the value of the frequency for the outgoing LIDAR signal and/or for the system output signal carrying channel λᵢ.

The electronics can include a light control component 322 that receives the indicator signal. The light control component 322 can control the laser source 68 (FIG. 1B) that is the source of the channel received by the control component 74 in response to the indicator signal. For instance, the laser source 68 can be controlled in a control architecture where the frequency of the channel signal output by the laser source 68 serves as a control process variable. When the control process variable is the frequency of the channel signal, the desired frequency for the system output signal serves as the reference variable. Because the frequency for the system output signal is modulated, the desired frequency for the system output signal changes as a function of time. For triangular modulation, FIG. 9C can represent an example of the desired waveform. FIG. 9C illustrates the desired frequency of the channel signal, and accordingly the resulting system output signal, as a linear function of time. Accordingly, the control component 74, process variable identification component 320, and light control component 322 that receive channel λᵢ can be part of a control mechanism that controls the laser source 68 that is the source of channel λᵢ such that the frequency of the channel signal output from the laser source 68 substantially maintains the desired waveform. Suitable control mechanisms include, but are not limited to, control architectures that make use of feedback control and/or feed forward control. Accordingly, the control mechanism can be a feedback control loop and/or can include a control loop.

The light control component 322 can control the characteristics of the channel signal and/or system output signal, in response to the value of an error signal determined from the value of the control process variable at a particular point in time and the value of the reference variable at the same point in time. For instance, the light control component 322 can control the characteristics of the channel signal so as to reduce the value of the error signal. As an example, the light control component 322 can control the characteristics of the channel signal such that the value of the control process variable moves toward to the value of the reference variable. In some instances, the control mechanism is a control loop such as a feedback control loop. When the control mechanism is a feedback control loop, the error signal for the control mechanism can be equal to the difference between the value of the control process variable and the value of the reference variable at a particular point in time.

When the process variable is the frequency of the channel signal, the light control component 322 can transmit a light control signal that tunes the frequency of the channel signal. For instance, the light control component 322 can tune the frequency of the channel signal by transmitting a light control signal that changes the level of electrical current through the laser source that outputs the channel signal. Other light control signals are possible. For instance, when the laser source is an electrostatic MEMS tunable laser, the light control component 322 can tune the frequency of the channel signal by transmitting a light control signal that changes the level of voltage that moves the MEMS facet of the MEMS tunable laser.

In some instances, the light control component 322 and/or the process variable identification component 320 actually quantify the frequency of the channel signal (f_{CS}); however, this quantification is not necessary. For instance, when the indicator signal is an analog signal that includes a characteristic that is related to the frequency of the channel signal (f_{CS}), the light control signal can be derived directly from the indicator signal without actually quantifying the frequency of the channel signal (f_{CS}). For instance, the control signal may be a one-to-one function of the indicator signal and/or of a transformed signal discussed below. As an example, the control signal may be a one-to-one function of the instantaneous frequency.

FIG. 10C illustrates the amplitude for the in-phase and quadrature components of the optical process variable signal and/or the process variable signal on the same time axis with the frequency of the system output signal. For instance, FIG. 10C can compare the frequency of the system output signal during the first two data periods shown in FIG. 9C compared against the variation of the in-phase and quadrature components of the optical process variable signal and/or the process variable signal. Although FIG. 10C illustrates the optical process variable signal and/or the process variable signal having only one period per data period, the optical process variable signal and/or the process variable signal can have more than one period per data period.

A variety of process variable identification components 320 can be used to determine a value for the process variable indicator. FIG. 10D illustrates one example of a process variable identification component 320 that is suitable for use when the process variable is the frequency of a channel signal and/or a system output signal. The illustrated process variable identification component 320 includes a local oscillator 324 that outputs a local signal that includes first local signal and a second local signal. The first local signal and the second local signal each carries a different one of the components selected from the group consisting of an in-phase component of the local signal and a quadrature component of the local signal.

The process variable identification component 320 also includes a first multiplier 326 that receives the first process variable signal and the first local signal. The first multiplier 326 multiplies the first process variable signal and the first local signal. When the first process variable signal carries the in-phase component of the process variable signal, the first local signal carries the quadrature component of the local signal. When the first process variable signal carries the quadrature component of the process variable signal, the first local signal carries the in-phase component of the local signal. The first multiplier 326 outputs a first multiplied signal.

The process variable identification component 320 also includes a second multiplier 328 that receives the second process variable signal and the second local signal. The second multiplier 328 multiplies the second process variable signal and the second local signal. When the second process variable signal carries the in-phase component of the process variable signal, the second local signal carries the quadrature component of the local signal. When the second process variable signal carries the quadrature component of the process variable signal, the second local signal carries the in-phase component of the local signal. The second multiplier 326 outputs a second multiplied signal.

The process variable identification component 320 includes an adder 330 that receives the first multiplied signal and the second multiplied signal. The adder 330 adds the first multiplied signal and the second multiplied signal and outputs a control signal.

The control signal is received at a process variable evaluator 334. The process variable evaluator 334 uses the control signal to output an indicator signal with one or more characteristics that are related to the frequency of the channel signal (f_{CS}). For instance, the process variable evaluator 334 can be a Time-to-Digital Converter (TDC) that outputs an indicator signal with a voltage that is related to the frequency of the channel signal (f_{CS}). In some instances, the Time-to-Digital Converter (TDC) outputs an indicator signal with a voltage that is proportional to the frequency of the channel signal (f_{CS}). The indicator signal can be received by the light control component 322 for use in controlling the frequency of the laser source.

Another example of a suitable process variable evaluator 334 is a frequency counter that outputs an indicator signal that indicates a time between baseline crossings (dn) of the control signal. The frequency determined for the channel signal (f_{CS}) can be related to the time between baseline crossings (dn) by Equation 1: f_{TS}=f_{LO}−1/(2*dn) where f_{LO} represents the frequency of the local oscillator. The process variable evaluator 334 can output an indicator signal that carries data indicating a value of the frequency determined for the channel signal (f_{CS}). The indicator signal can be received by the light control component 322 for use in controlling the frequency of the laser source.

The local signal is selected such that the frequency of the control signal is higher than the frequency of the process variable signal. The increased frequency of the control signal increases the frequency that the process variable can be accurately sampled. Increasing this sampling frequency provides more accurate control of the process variable by the control mechanism. As a result, the increased frequency of the control signal enhances the control of the process variable by the control mechanism. Suitable sampling frequencies include, but are not limited to, sampling frequencies greater than 100 times the modulation frequency, where the modulation frequency is 1/(duration of a cycle). In some instances, all or a portion of the data periods in each cycle have a sampling frequency greater than 30 or 100 times per duration of the data period. In some instances, the local signal is selected such that the frequency of the control signal is more than 100, and less than 10,000 times higher than the frequency of the process variable signal.

FIG. 10E illustrates another example of a suitable process variable identification component 320 that is suitable for use when the process variable is the frequency of a channel signal and/or a system output signal. The process variable identification component 320 includes an Analog-to-Digital Converter (ADC) 340 that receives the control signal from the adder 330. The Analog-to-Digital Converter (ADC) 340 converts the first process variable signal from an analog form to a digital form and outputs a digital data signal. The digital data signal is a digital representation of the control signal.

The process variable identification component 320 includes a transform component 342 that receives the digital data signal. The transform component 342 performs a mathematical transform on the digital data signal. The mathematical transform is selected such that the transform component 342 outputs a transformed signal that is related to, includes or indicates the frequency of the LIDAR output signal. A suitable first mathematical transform includes, but is not limited to, a Hilbert transform. A Hilbert transform outputs a transformed signal that indicates the instantaneous phase and, consequently, frequency of the control signal.

The transformed signal is received by a frequency evaluator 344. The frequency evaluator can be configured to output an indicator signal that is related to, includes and/or indicates the frequency of the LIDAR output signal. For instance, the frequency evaluator can convert the instantaneous frequency to the frequency of the channel signal (f_{CS}) by f_{CS}=(finst−f_{LO})*(T/τ′), where f_{LO} is the frequency of the local oscillator, finst is the instantaneous frequency extracted from the Hilbert Transform, T is the duration of a data period in a triangular modulation scheme, and τ′ is the delay resulting from the length differential between the delay waveguide 62 and the expedited waveguide 66. Accordingly, the indicator signal can be a digital signal that quantifies the frequency of the frequency of a channel signal (f_{CS}). The indicator signal can be received by the light control component 322 for use in controlling the frequency of the laser source.

Although the indicator signal is described in the context of a signal that carries data regarding the frequency of a channel signal, the indicator signal can carry data that is indirectly related to the frequency of the channel signal. For instance, the indicator signal can carry data that can be used to determine the frequency of a channel signal. As an example, the frequency of a channel signal (f_{TS}) can be determined from the rate of phase change of the channel signal. Accordingly, the indicator signal can carry data that indicates the rate of phase change of the channel signal.

The process variable identification component 320 reduces the amount of delay that needs to be created by the delay waveguide 62 because it increases the sensitivity of the indicator signal to the frequency of the channel signal by combining the information from in-phase and quadrature components at any given time. Prior systems attempted to increase this sensitivity by increasing the length of the delay pathway. Because the process variable identification component 320 increases the sensitivity of the indicator signal, the length of the delay pathway can exceed the length of the expedited pathway by a lower amount than could be achieved in prior systems. For instance, the time delay in the pathway to a control component 74 can exceed the time delay in the expedited pathway to the control component 74 by an amount that is greater than or equal to 50 ps and less than or equal to 100 ns. In one example, the length of the delay pathway exceeds the length of the expedited pathway by an amount that is less than 1000 cm, less than 500 cm, or less than 100 cm and is greater than 0.0 cm or 0.4 cm. In one example, the delay pathway and the expedited pathway to the same control component 74 guide light through silicon and the length of the delay pathway exceed the length of the expedited pathway by an amount that is less than 1000 cm and greater than 0.0 cm or 0.4 cm.

FIG. 10A through FIG. 10E illustrate an example of a suitable control component for use as all or a fraction of the control component 74 disclosed in the context of FIG. 1A through FIG. 4. As discussed above, each of the control component 74 receives a delay pathway signal and an expedited pathway signal carrying the same channel. In some instances, a laser source 68 is constructed such that different channel signals each carry a different one of the channels and the different channel signals are each output from a different laser source 68. For instance, FIG. 1B illustrates a possible light source 10 construction where different channel signals are each output from a different laser source 68. In these instances, each of the different control components 74 can be used to control the source of the channel signal that carries the channel received by the control component. For instance, each of the different control components 74 can be included in a feedback control loop that operates the laser sources so as to control the frequency of the channel signal that carries the channel received by the control component and accordingly to control the system output signal carrying the same channel. The electronics can independently operate the feedback control loops and can accordingly independently operate the laser sources within those feedback control loops.

The above LIDAR systems illustrate a single system output signal carrying each of the channels. As a result, each control mechanism can control the frequency versus time pattern of a different one of the single system output signals. However, the LIDAR system can be constructed such that multiple different system output signals carry the same channel. For instance, the LIDAR output signal can be divided into multiple different signals that are each used as the source of a system output signal. In this instance, one or more of the control mechanisms can each control the frequency versus time pattern of multiple different system output signals that each carry the same channel.

The control components disclosed in the context of FIG. 10A through FIG. 10E operate on an in-phase component of a process variable signal and the quadrature component of the process variable signal. However, the control components can be configured to operate on the in-phase component of the process variable signal and can exclude the quadrature component of the process variable signal. As a result, the control components can exclude the second light-combining component 286. Accordingly, the control components can include one light-comber and the delay pathway and expedited pathway to a control component can extend to only one light-combiner in the control component.

Although the LIDAR system is disclosed as having multiple control mechanisms that each includes one of the control components 74, the LIDAR system can include as few as one control mechanism. For instance, the laser sources 68 can be configured such that tuning the frequency of one laser source 68 at a rate αᵢ tunes the other laser source 68 at the same rate. In this instance, controlling one of the laser source 68 as disclosed above provides the desired tuning for each of the laser sources and accordingly provides each of the system output signals with the desired frequency versus time pattern.

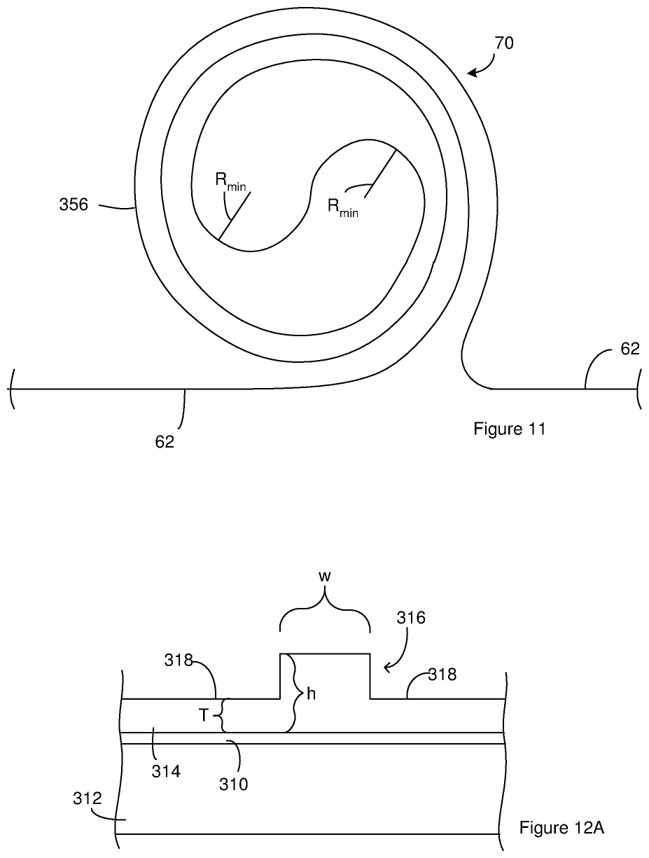

As noted above, delay waveguides such as a delay waveguide 62 and/or a first delay waveguide 80 can include a delay section 70 that can be used to increase the length of the delay waveguide beyond the length of the expedited waveguide 66. The delay section 70 can represent a spiral arrangement of the delay waveguide 62. The spiral arrangement is selected to reduce the amount of space occupied by longer waveguides such as a delay waveguide 62 and/or a first delay waveguide 80. FIG. 11 illustrates a portion of a delay waveguide 62 or a first delay waveguide 80 having a spiral arrangement that serves as the delay section 70. Near the center of the spiral arrangement, the waveguide turns back upon itself. The spiral configuration is selected such that the portion of the waveguide with the smallest radius of curvature of the waveguide in the spiral arrangement (labeled Rₘᵢₙ in FIG. 11) has a radius of curvature above a curvature threshold. Suitable curvature thresholds include, but are not limited to, curvature thresholds above or equal to 0.1 mm, 0.25 mm, and 0.5 mm. Although the spiral arrangement is shown in a geometry that approximates a circle, the spiral arrangement can be in other geometries such as shapes that approximate an oval, rectangle or triangle. As a result, the spiral arrangement can include straight waveguide segments and/or substantially straight waveguide segments.

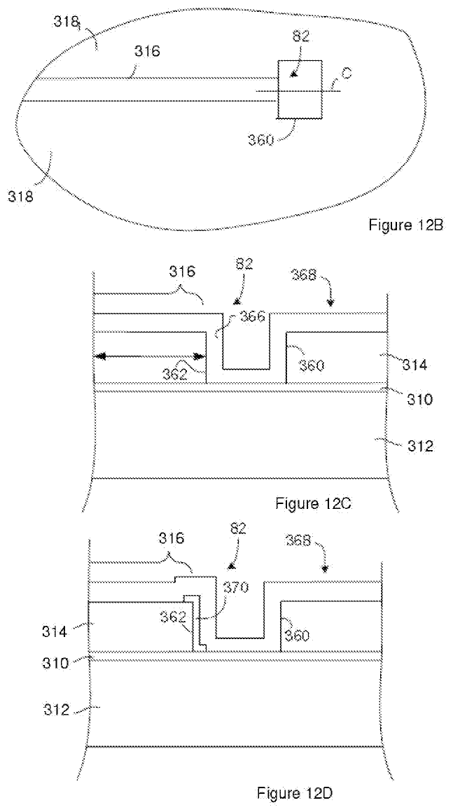

Suitable platforms for the LIDAR chip and the scanning chips include, but are not limited to, silica, indium phosphide, and silicon-on-insulator wafers. FIG. 12A is a cross-section of portion of a chip constructed from a silicon-on-insulator wafer. A silicon-on-insulator (SOI) wafer includes a buried layer 310 between a substrate 312 and a light-transmitting medium 314. In a silicon-on-insulator wafer, the buried layer 310 is silica while the substrate 312 and the light-transmitting medium 314 are silicon. The substrate 312 of an optical platform such as an SOI wafer can serve as the base for the entire LIDAR chip. For instance, the optical components shown on the LIDAR chips of FIG. 1A through FIG. 4 can be positioned on or over the top and/or lateral sides of the substrate 312.

FIG. 12A is a cross section of a portion of a LIDAR chip that includes a waveguide construction that is suitable for use in LIDAR chips constructed from silicon-on-insulator wafers. A ridge 316 of the light-transmitting medium extends away from slab regions 318 of the light-transmitting medium. The light signals are constrained between the top of the ridge 316 and the buried layer 310.

The dimensions of the ridge waveguide are labeled in FIG. 12A. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction disclosed in the context of FIG. 12A is suitable for all or a portion of the waveguides on LIDAR chips constructed according to FIG. 1A through FIG. 4.

FIG. 12B through FIG. 12D illustrate an example of a return device 82 constructed on a silicon-on-insulator platform and suitable for use on a LIDAR chip constructed according to FIG. 2 and FIG. 4. FIG. 12B is a topview of a portion of a LIDAR chip that has the return device 82. FIG. 12C is a cross section of the return device 82 taken along the line labeled C in FIG. 12B. FIG. 12D is a cross section of the return device 82 taken along the line labeled C in FIG. 12B.

The illustrated return device 82 includes a recess 360 that extends partially or fully through the light-transmitting medium 314. Although the illustrated recess 360 does not extend into the buried layer 310, the illustrated recess 360 can extend into or through buried layer 310. A surface of the recess 360 serves as a return surface 362. The return surface 362 is configured such that at least a portion of the light signal that is incident on the return surface 362 from the light-transmitting medium 314 returns to the light-transmitting medium 314. The mechanism by which the return occurs can be reflection at or by the return surface 362. For instance, a recess medium 366 can be positioned in the recess 360 and in contact with the return surface 362. The recess medium 366 can fill the recess 360 or be a layer of material that contacts the return surface 362. The recess medium 366 can be a fluid or a solid. As shown in FIG. 12C, the recess medium 366 can be a solid that also serves as a cladding 368. In some instances, the recess medium 366 has a lower index of refraction than the light-transmitting medium 314 to cause reflection at the return surface 362. Suitable recess media with an index of refraction lower than the light-transmitting medium 314 include, but are not limited to, air, epoxies, silicon dioxide, and silicon nitride. Suitable recess media with an index of refraction lower than the light-transmitting medium 314 that can also serve as cladding include, but are not limited to, silicon dioxide, and silicon nitride.

In some instances, the recess medium 366 is a medium that causes the outgoing LIDAR signal or input signal to be reflected at the return surface 362. For instance, the recess medium 366 can be a reflective material 370 that contacts the return surface 362. FIG. 12D illustrates a layer of reflective material 370 in contact with the return surface 362. Although FIG. 12D illustrates a cladding positioned such that the cladding is located over the recess medium 366 and extends into the recess 360, the cladding is optional. Suitable reflective materials 370 include, but are not limited to, multi-layer dielectric films including silicon dioxide, hafnium oxide and aluminum oxide, and metals such as aluminum, nickel, and gold. Suitable claddings include, but are not limited to, silicon dioxide, silicon nitride, and aluminum oxide.

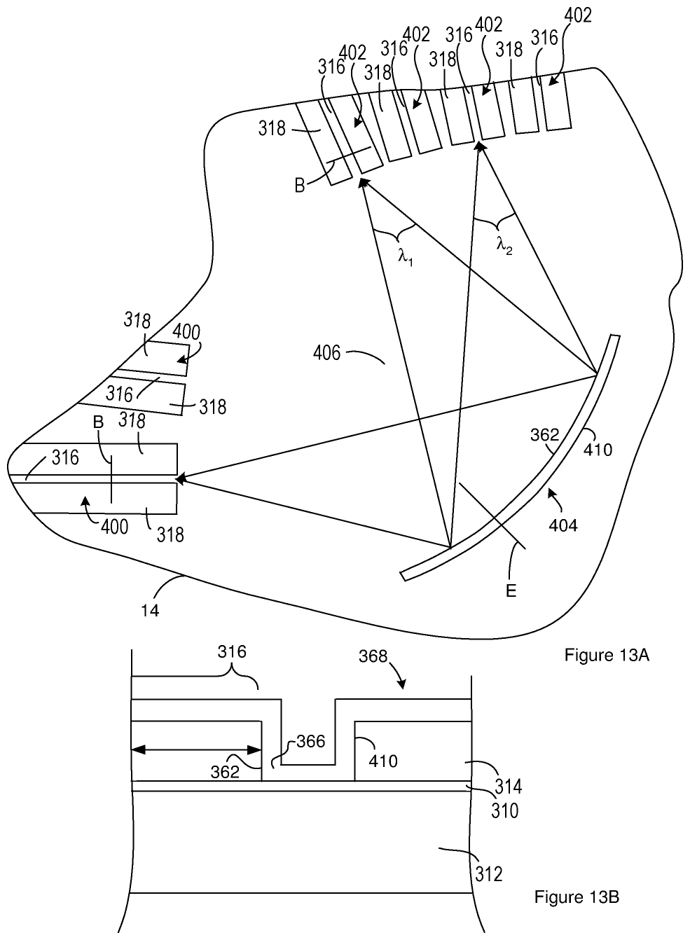

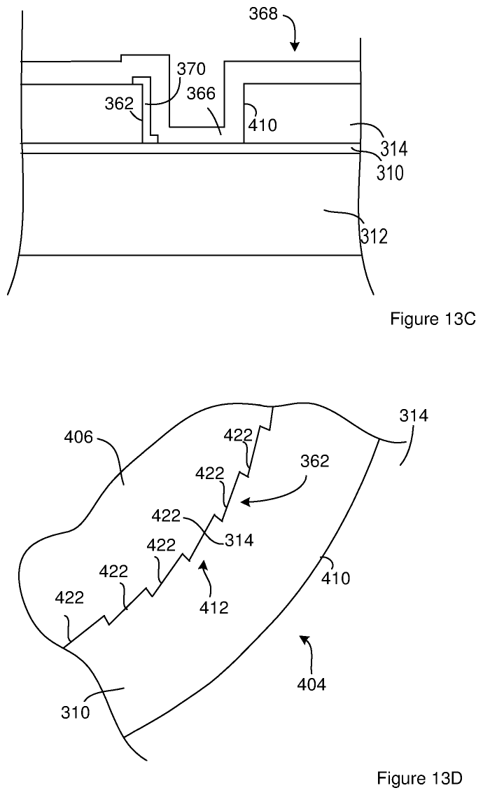

As noted above, the splitter 120 can be a wavelength dependent splitter. Suitable wavelength dependent splitters include, but are not limited to, array waveguide gratings, and echelle gratings. FIG. 13A through FIG. 13D illustrate an example of an echelle grating constructed on a silicon-on-insulator platform and suitable for use as the splitter 120 and/or a wavelength dependent splitter in the LIDAR systems. For the purposes of illustration, the echelle grating is illustrated in the context of the splitter 120 on the scanning chip; however, the illustrated echelle grating construction can be employed for a splitter on the LIDAR chip or on the scanning chip.

The scanning chip includes one or more first splitter waveguides 400, second splitter waveguides 402, and a signal redirector 404 positioned around a free space region 406. When the echelle grating serves as the splitter 120, the first splitter waveguides can each be one of the alternate waveguides 119 and the second splitter waveguides 402 can each be one of the channel output waveguides 121.

The first splitter waveguides 400 can each guide the switch signal to the free space region 406. The switch signal travels through the free space region 406 to the signal redirector 404 and directs light from the switch signal toward the second splitter waveguides 402. As a result, the light from the switch signal travels from the signal redirector 404, through the free space region 406 toward the second splitter waveguides 402.

The signal redirector 404 is constructed such that different wavelengths carried in the second signal separate into the channel output signals as they travel away from the free space region 406. For instance, FIG. 13A shows the channel output signals carrying the channels labeled λ₁, and λ₂ separating as they travel away from the signal redirector 404. The second splitter waveguides 402 terminate at location where a portion of the second splitter waveguide 402 each receives one of the channel output signals. The portion of the second splitter waveguide 402 that each receives one of the channel output signals changes as the first splitter waveguide 400 that carries the switch signal changes.

The echelle grating of FIG. 13A can be operated in the reverse direction as a multiplexer. For instance, the channel output signal labeled λ_{A} can represent the channel return signal carrying channel λ_{A} and the channel output signal labeled λ_{B} can represent the channel return signal carrying channel λ_{B}. The channel return signals can travel from the second splitter waveguides 402, through the space region 406 to the signal redirector 404. The signal redirector 404 can direct light from the channel return signals toward the first splitter waveguides 400. The signal redirector 404 is configured such that light from the channel return signals combines to form the assembly return signal. The assembly return signal is received by the first splitter waveguide 400 that output the switch signal.

The echelle grating of FIG. 13A is shown built on a silicon-on-insulator platform; however, other platforms can be used. The first splitter waveguides 400 and/or the second splitter waveguides 402 can be constructed as disclosed in the context of FIG. 12A. For instance, FIG. 12A can represent a cross-section of FIG. 13A taken at any of the lines labeled B in FIG. 13A.

FIG. 13B is a cross section of the echelle grating taken through the signal redirector 404 as illustrated by the line labeled E in FIG. 13A. The illustrated signal redirector 404 includes a recess 410 that extends partially or fully through the light-transmitting medium 314. Although the illustrated recess 410 does not extend into the buried layer 310, the illustrated recess 410 can extend into or through buried layer 310. A surface of the recess 410 serves as a return surface 362. The return surface 362 is configured such that at least a portion of the switch signal or the channel return signals that are incident on the return surface 362 from the light-transmitting medium 314 returns to the light-transmitting medium 314. The mechanism by which the return occurs can be reflection at or by the return surface 362. For instance, a recess medium 366 can be positioned in the recess 410 and in contact with the return surface 362. The recess medium 366 can fill the recess 410 or be a layer of material that contacts the return surface 362. The recess medium 366 can be a fluid or a solid. As shown in FIG. 13B, the recess medium 366 can be a solid that also serves as a cladding 416 for all or a portion of the LIDAR chip. In some instances, the recess medium 366 has a lower index of refraction than the light-transmitting medium 314 to cause reflection at the return surface 362. Suitable recess media with an index of refraction lower than the light-transmitting medium 314 include, but are not limited to, air, epoxies, silicon dioxide, and silicon nitride. Suitable recess media with an index of refraction lower than the light-transmitting medium 314 that can also serve as cladding include, but are not limited to, silicon dioxide, and silicon nitride.

In some instances, the recess medium 366 is a medium that causes the outgoing LIDAR signal or input signal to be reflected at the return surface 362. For instance, the recess medium 366 can be a reflective material 370 that contacts the return surface 362. FIG. 13C illustrates a layer of reflective material 370 in contact with the return surface 362. Suitable reflective materials 370 include, but are not limited to, multi-layer dielectric films including silicon dioxide, hafnium oxide and aluminum oxide, and metals such as aluminum, nickel, and gold. Suitable claddings include, but are not limited to, silicon dioxide, silicon nitride, and aluminum oxide.

FIG. 13D is a close-up topview of a portion of the return surface 362 without the recess medium 366 or the reflective material 370 positioned in the recess 410. The return surface 362 is configured to act an optical grating. For instance, the return surface 362 includes multiple grooves 422 arranged such that the signal redirector 404 serves as an echelle grating. Suitable groove 422 structures include, but are not limited to, steps. The bandwidth of an optical filter that includes or consists of the echelle grating can be tuned by changing the focal length and/or by changing the grating dimensions.

The free space region 406 can constrain the light signal in one direction. For instance, the free space region 406 of FIG. 13A through FIG. 13D can vertically constrain light signals. In these instances, the light signal can spread in the lateral directions and/or become more focused in the lateral directions. As a result, all or a portion of the free space region 406 can be slab waveguides.

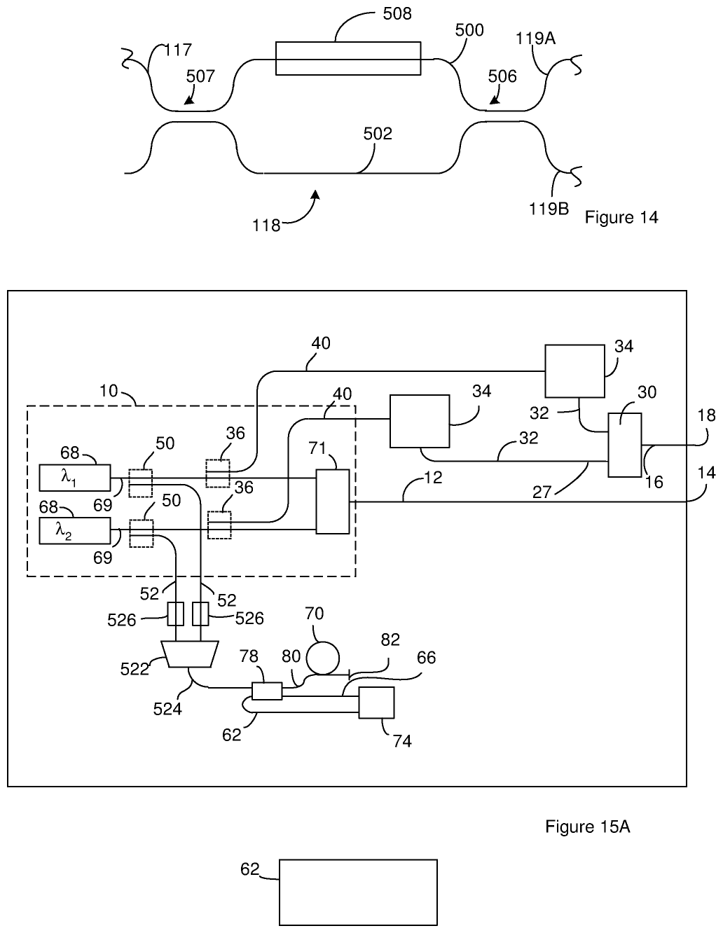

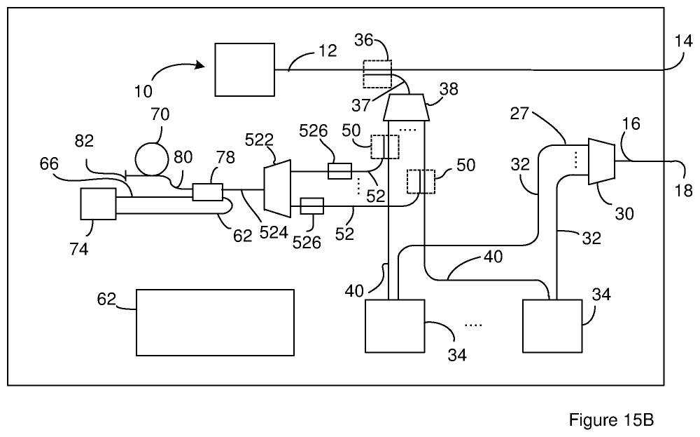

A variety of optical switches that are suitable for use with the LIDAR system can be constructed on planar device optical platforms such as silicon-on-insulator platforms. Examples of suitable optical switches for integration into a silicon-on-insulator platform include, but are not limited to, Mach-Zehnder interferometers. FIG. 14 is a schematic of a Mach-Zehnder interferometer. The switch includes a first switch waveguide 500 that connects the common waveguide 117 and a first one of the alternate waveguides 119A. A second one of the alternate waveguides 119B is connected to a second switch waveguide 502. The first switch waveguide 500 and the second switch waveguide 502 are included in a first optical coupler 504 and in a second optical coupler 506. A phase shifter 508 is positioned along the first switch waveguide 500 or the second switch waveguide 502 between the first optical coupler 504 and the second optical coupler 506. Suitable phase shifters include, but are not limited to, PIN diodes, PN junctions operated in carrier depletion mode, and thermal heaters.

The electronics can operate the phase shifter so as to change the switch between a pass mode and a switched mode. In the pass mode, the switch signal carried on the common waveguide 117 passes through to the first alternate waveguides 119A. In the switched mode, the switch signal carried on the common waveguide 117 is directed to the second alternate waveguides 119B.

Although the optical switch illustrated in FIG. 14 is suitable for a LIDAR system that directs the switch signal to one of two alternate waveguides 119A, the LIDAR system can direct the switch signal more than two alternate waveguides 119A. In these instances, switches such as the optical switch of FIG. 14 can be cascaded such that the electronics can direct the switch signal more than two alternate waveguides 119A.

The LIDAR chip can include a control assembly other than the control assemblies disclosed above. Suitable examples of control assemblies are disclosed in U.S. patent application Ser. No. 17/244,869, filed on Apr. 29, 2021, entitled “Reducing Size of LIDAR System Control Assemblies,” and incorporated herein in its entirety.

FIG. 15A illustrates the control assembly of FIG. 4 modified such that a control component 74 concurrently receives a series of different channels. As described in the context of FIG. 4, each of the splitters 50 moves a portion of the channel signal from a source waveguide 69 onto a control waveguide 52. The portion of the channel signal received by a control waveguide 52 can serves as the tapped signal. Because each of the channel signals carries a different one of the channels, the light in each of the tapped signals carries a different one of the channels.

Each of the control waveguides 52 carries one of the tapped signals to a signal mixer 522 that outputs the tapped signals on a common channel waveguide 524. The signal mixer can be a wavelength dependent mixer such as a multiplexer. Alternately, the signal mixer can be a wavelength independent mixer such as a y-junction, cascaded y-junction, multi-mode interferometer (MMI), or star coupler.

An attenuator 526 is positioned along each of the control waveguides 52. The attenuators can be operated by the electronics 62. The electronics 62 can operate the attenuators 526 such that one of the tapped signals is received by the signal mixer 522 and output to the common channel waveguide 524 to serve as a selected signal. The attenuators 526 are operated such that the one or more tapped signals that are not the selected signal are sufficiently attenuated to be effectively blocked from being received by the signal mixer 522. As a result, the one or more tapped signals that are not the selected signal are not output on the common channel waveguide 524. Accordingly, the electronics 62 can operate the attenuators 526 so as to select which one of the tapped signals are output on the common channel waveguide 524. The combination of the attenuators 526 and the signal mixer can operate as an optical switch. As a result, an optical switch can replace the illustrated attenuators 526 and signal mixer 522.

The tapped signal that is output on the common channel waveguide 524 can serve as the selected signal. The common channel waveguide 524 carries the selected signal to the splitter 78. The splitter 78 divides the selected signal into the expedited signal and a first delayed signal. The expedited signal is received on the expedited waveguide 66 and the first delayed signal is received on the first delay waveguide 80 as described in the context of FIG. 4. Accordingly, light from the selected signal travels a delay pathway from the splitter 78 to the control components 74 and light from the tapped signal also travels an expedited pathways from the splitter 78 to the control component 74. As noted above, the control component receives a delay pathway signal carrying one of the channels from the delay pathway and concurrently receives an expedited pathway signal carrying the same channel from the expedited pathway.

The electronics 62 operate the attenuator 526 such that a series of different tapped signals that carry different channels are received at the signal mixer 522. For instance, the electronics 62 can operate the attenuator 526 such that tapped signals that each of the different channels are serially received at the signal mixer 522. As a result, the selected signal carries a series of different channels. Accordingly, the channel carried by the delay pathway signal and the expedited pathway signal receives at the control component 74 changes serially. The control component 74 can be operated as disclosed above. For instance, the light control component 322 (FIG. 10D and FIG. 10E) can control the laser source 68 (FIG. 15A) that is the source of the channel received by the control component 74 in response to the indicator signal that results from the control component 74 receiving that channel. As a result, the control component 74 and/or the light control component 322 can serially control the different laser sources 68.

Rather than the tapping a source waveguide 69 as shown in FIG. 15A, each of the splitters 50 can configured to move a portion of a reference signal from one of the reference waveguides 40 onto a control waveguide 52 as shown in FIG. 15B. The portion of the channel signal received by a reference waveguides 40 can then serve as the tapped signal. Such an arrangement may be desirable when a channel signal out from a laser source 68 carries more than one wavelength channel.

In some instances, it may be possible to remove the LIDAR adapter from the LIDAR system. In these instances, the components from the scanning chip can optionally be integrated with the LIDAR chip. The optical switch 118 can receive the outgoing LIDAR signal from the utility waveguide 12. Accordingly, the portion of the outgoing LIDAR signal received at the switch can serve as the switch signal. Additionally, the input waveguide 16 receives the incoming LIDAR signal from the splitter 36 rather than from the adapter.

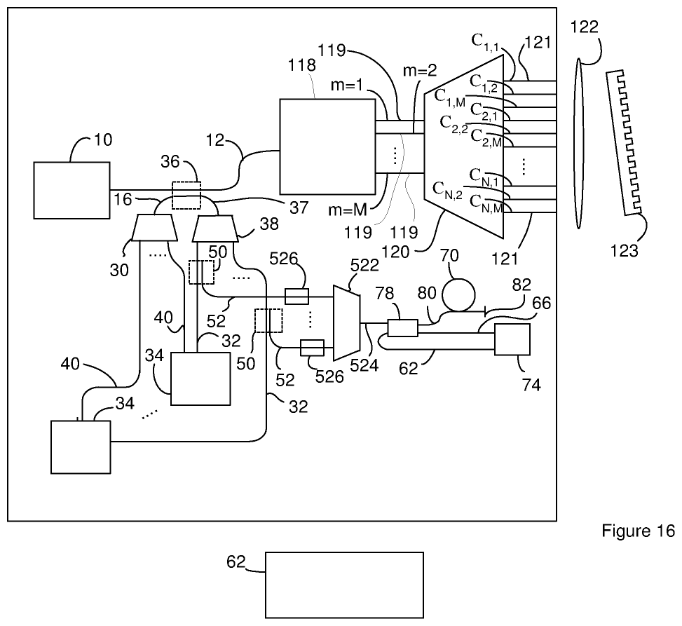

For instance, FIG. 16 illustrates the LIDAR system of FIG. 15B modified so as to exclude the LIDAR adapter. When an object is present in a sample region that is being illuminated by a system output signal, the object can reflect light from the system output signal. The reflected light returns to the LIDAR system in a system return signal. Each of the system returns signals can carry a different one of the channels. The system return signals can be received by the optical grating 123. The optical grating 123 can be configured to output at least a portion of each system output signal. The portion of each system output signal output from the optical grating 123 can serve as a channel return signal. The optical grating 123 outputs the channel return signals such that the channel return signal carrying wavelength channel i (λᵢ) travels along the same or substantially the same path as the channel output signal carrying wavelength channel i (λᵢ) but in the reverse direction. Additionally, the channel return signal carrying wavelength channel i travels along the same or substantially the same path through the signal redirector 122 as the channel output signal carrying wavelength channel i (λᵢ) but in the reverse direction.

The scanning chip can receive channel return signals that each includes or consists of light from a different one of the system return signals. For instance, the scanning chip can receive the channel return signals from the signal redirector 122. As an example, the channel output waveguides 121 receive the channel return signal that carries the same wavelength channel as the channel output signal output from the channel output waveguide 121. For instance, during a sample region illumination period, the channel return signal carrying channel λᵢ returns to the channel output waveguide 121 that output the channel output signal carrying channel λᵢ during the sample region illumination period. Because a portion of the channel output waveguides 121 do not output a channel output signal during the sample region illumination period, a portion of the channel output waveguides 121 do not receive a channel return signal during sample region illumination period but may receive a channel return signal during a different sample region illumination period.

The channel output waveguides 121 carry the received channel return signal to the splitter 120. The splitter 120 combines the channel return signals into an assembly return signal received on the one of the alternate waveguides 119. Accordingly, the splitter 120 can operate as a demultiplexer/multiplexer. The alternate waveguide 119 that receives the assembly return signal carries the assembly return signal to the optical switch 118. The optical switch 118 guides the assembly return signal to the utility waveguide 12. The utility waveguide 12 carries the assembly return signal to the splitter 36. The splitter 36 that moves at least a portion of the assembly return signal the utility waveguide 12 onto the input waveguide 16. The portion of the assembly return signal that enters the input waveguide 16 serves as the incoming LIDAR signal. As described above, the input waveguide 16 carries the incoming LIDAR signal to the comparative demultiplexer 30.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first auxiliary light sensor 218, the second auxiliary light sensor 220, the first light sensor 223, and the second light sensor 224.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the auxiliary light sensor 218, the second auxiliary light sensor 220, the first light sensor 223, and the second light sensor 224.

A suitable laser source 68 can be a laser chip that is separate from the LIDAR chip and then attached to the LIDAR chip. For instance, a laser source 68 can be a laser chip that is attached to the chip using a flip-chip arrangement. Use of flip-chip arrangements is suitable when a laser source 68 is to be interfaced with a ridge waveguide on a chip constructed from silicon-on-insulator wafer. Alternately, the utility waveguide 12 can include an optical grating (not shown) such as Bragg grating that acts as a reflector for an external cavity laser. In these instances, the laser source 68 can include a gain element that is separate from the LIDAR chip and then attached to the LIDAR chip in a flip-chip arrangement. Examples of suitable interfaces between flip-chip gain elements and ridge waveguides on chips constructed from silicon-on-insulator wafer can be found in U.S. Pat. No. 9,705,278, issued on Jul. 11, 2017 and in U.S. Pat. No. 5,991,484 issued on Nov. 23, 1999; each of which is incorporated herein in its entirety. When the laser source 68 is a gain element or laser chip, the electronics 62 can change the frequency of the channel signal by changing the level of electrical current applied to through the gain element or laser cavity.

Suitable electronics 62 can include, but are not limited to, an electronic controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the electronic controller has access to a memory that includes instructions to be executed by the electronic controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demultiplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demultiplexers, tunable multiplexers.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A LIDAR system, comprising:
a switch configured to direct a switch signal to one of multiple different alternate waveguides such that the alternate waveguide to which the switch directs the switch signal receives the switch signal from the switch, the switch signal carrying multiple different channels; and
an optical grating configured to receive multiple different channel output signals, each of the different channel output signals including light from the switch signal and carrying a different one of the channels,
the optical grating configured to output that channel output signals such that a direction that each of the channel output signals travels away from the optical grating changes in response to a change in the alternate waveguide to which the switch directs the switch signal.

2. The system of claim 1, wherein the optical grating is selected from a group consisting of a diffraction grating, holographic diffraction grating, and a digital planar holographic diffraction grating.

3. The system of claim 1, wherein the LIDAR system is configured to output multiple system output signals that each carries a different one of the channels, a direction that each of the system output signals travels away from the LIDAR system changes in response to changes in the alternate waveguide to which the switch directs the switch signal.

4. The system of claim 1, wherein the optical grating receives the different channel output signals from a lens and the lens is configured such that a direction that each of the channel output signals travels away from the lens changes in response to a change in the alternate waveguide to which the switch directs the switch signal.

5. The system of claim 1, further comprising a splitter configured to receive the switch signal from the alternate waveguide to which the switch directs the switch signal,
the splitter being configured to divide the switch signal into the multiple different channel output signals.

6. The system of claim 5, wherein the splitter is a demultiplexer.

7. The system of claim 5, wherein an optical pathway that each of the channel output signals travels from the splitter to the optical grating passes through a lens.

8. The system of claim 7, wherein the channel output signals are each incident on a different region of the lens.

9. The system of claim 5, wherein the splitter includes multiple first splitter waveguides and multiple second splitter waveguides,
the splitter configured to receive the switch signal on one of the first splitter waveguides, and
the splitter configured to output the channel output signals on a portion of the second splitter waveguides.

10. The system of claim 9, wherein the splitter includes at least 4 first splitter waveguides and at least 16 second splitter waveguides.

11. The system of claim 10, wherein the system is configured to output system output signals that each includes light from a different one of the channel output signals and a field of view angle for the system output signals is greater than 20° and less than 60°.

12. The system of claim 9, wherein each of the second splitter waveguides terminates at a facet and a center-to-center distance between the facets is between 5 μm and 100 μm.

13. The system of claim 9, wherein the portion of the second splitter waveguides on which the channel output signals are output changes in response to a change in the first splitter waveguide that receives the switch signal.

14. The system of claim 9, wherein the portion of the second splitter waveguides on which the channel output signals are output changes in response to a change in the alternate waveguide which receives the switch signal.

15. The system of claim 9, wherein each of the alternate waveguides serves as one of the first splitter waveguides.

16. The system of claim 9, wherein the splitter is a demultiplexer.

17. The system of claim 1, wherein each of the channel output signals had a different angle of incidence on the optical grating.

18. The system of claim 1, wherein the optical grating has a dispersion between 0.05 degrees/nm and 0.2 degrees/nm.

19. A method of operating a LIDAR system, comprising:
directing a switch signal to one of multiple different alternate waveguides such that the alternate waveguide to which the switch signal is directed receives the switch signal from the switch, the switch signal carrying multiple different channels;
receiving multiple different channel output signals at an optical grating, each of the different channel output signals including light from the switch signal and carrying a different one of the channels; and
changing the alternate waveguide to which the switch directs the switch signal,
a direction that each of the channel output signals travels away from the optical grating changes in response to the change in the alternate waveguide to which the switch directs the switch signal.
